(19) United States
(12) Patent Application Publication
(10) Pub. No.: US 2026/0177688 A1
(43) Pub. Date: Jun. 25, 2026

(54) ENHANCED SYSTEMS AND METHODS FOR SYNTHETIC APERTURE RADAR IMAGE COMPRESSION WITH CROSS POLARIZATION PREDICTION

(71) Applicant: AtomBeam Technologies Inc., Moraga, CA (US)

(72) Inventors: Zhu Li, Overland Park, KS (US); Paras Maharjan, Kansas City, MO (US)

(21) Appl. No.: 18/959,592

(22) Filed: Nov. 25, 2024

Related U.S. Application Data
(63) Continuation-in-part of application No. 18/928,182, filed on Oct. 28, 2024.
Application No. 18/928,182 is a continuation-in-part of application No. 18/885,741, filed on Sep. 16, 2024, now Pat. No. 12,554,010.
Application No. 18/885,741 is a continuation-in-part of application No. 18/792,542, filed on Aug. 1, 2024, now Pat. No. 12,392,891.

(51) Int. Cl. G01S 13/90; G06T 1/00; G06T 5/60; G06T 9/00

(52) U.S. Cl. CPC G01S 13/9021; G01S 13/9076; G06T 1/0007; G06T 5/60; G06T 9/002; G06T 2207/10028; G06T 2207/20084

(57) ABSTRACT

A system and method for processing Synthetic Aperture Radar (SAR) data using cross polarization prediction. The system processes complex SAR data from two different polarizations, typically HH and VV, and stores their representations. A specialized reconstruction component then reconstructs data from the first polarization while utilizing the second polarization data as auxiliary information. This cross-polarization approach enhances the reconstruction process, leveraging complementary information from both polarizations to produce improved SAR imagery. The method can employ neural network-based compression and reconstruction techniques, adaptive processing based on SAR data characteristics, and sophisticated analysis of cross-polarization relationships. Advanced implementations may include interpolation between polarizations, extrapolation of polarization effects, and arithmetic operations on processed representations to further enhance the SAR data. This innovation enables the generation of high-quality, information-rich SAR images with potential applications in environmental monitoring, urban planning, agriculture, and disaster response.

### CROSS-REFERENCE TO RELATED APPLICATIONS

Priority is claimed in the application data sheet to the following patents or patent applications, each of which is expressly incorporated herein by reference in its entirety:
Ser. No. 18/928,182
Ser. No. 18/885,741
Ser. No. 18/792,542

### BACKGROUND OF THE INVENTION

### Field of the Art

The present invention is in the field of data processing, and more particularly is directed to the problem of compressing synthetic aperture radar images.

### Discussion of the State of the Art

Synthetic aperture radar (SAR) is a form of radar technology that is used to create high-resolution images of landscapes. Unlike traditional radar systems, which rely on a large physical antenna, SAR uses the motion of the radar platform (such as an aircraft or satellite) to simulate a much larger antenna, or “synthetic aperture.” This allows SAR to achieve much higher resolution images than conventional radar. Accordingly, SAR can produce detailed images with resolutions that are often better than those obtained by optical sensors. Another benefit is that SAR can operate in any weather conditions (rain, fog, clouds) and during both day and night because it relies on microwave radiation, which can penetrate clouds and is independent of sunlight. Additionally, SAR can penetrate certain materials like vegetation, ice, and snow, allowing it to image objects or features hidden beneath these materials. Due to its capabilities, SAR images are well-suited for a wide variety of applications, including earth observation (via satellites), environmental monitoring, agriculture applications, military and defense applications, and more.

To acquire SAR images, the SAR system transmits a microwave signal towards the ground. The transmitted signal reflects off the surface and returns to the radar antenna. As the radar platform moves, it collects reflected signals from different positions along its path. These multiple reflections simulate a much larger antenna, creating a “synthetic aperture.” The collected data is processed to form an image. The phase and amplitude of the reflected signals are used to reconstruct a high-resolution image of the surface. Thus, synthetic aperture radar is a powerful remote sensing technology that provides high-resolution images and valuable data across a range of applications. Its ability to operate under various conditions and penetrate materials that block optical sensors makes it an essential tool in earth observation, environmental monitoring, defense, agriculture, and many other fields. The advantages of SAR make it a valuable tool in modern remote sensing and imaging technologies.

### SUMMARY OF THE INVENTION

Accordingly, there is disclosed herein, a system and method for processing synthetic aperture radar data using cross polarization prediction. The system processes complex SAR data from two different polarizations, typically HH and VV, and stores their representations. A specialized reconstruction component then reconstructs data from the first polarization while utilizing the second polarization data as auxiliary information. This cross-polarization approach enhances the reconstruction process, leveraging complementary information from both polarizations to produce improved SAR imagery. The method can employ neural network-based compression and reconstruction techniques, adaptive processing based on SAR data characteristics, and sophisticated analysis of cross-polarization relationships. Advanced implementations may include interpolation between polarizations, extrapolation of polarization effects, and arithmetic operations on processed representations to further enhance the SAR data. This innovation enables the generation of high-quality, information-rich SAR images with potential applications in environmental monitoring, urban planning, agriculture, and disaster response.

According to a preferred embodiment, a system for processing Synthetic Aperture Radar (SAR) data using cross polarization prediction, comprising: a computing device comprising at least a memory and a processor; a plurality of programming instructions stored in the memory and operable on the processor, wherein the plurality of programming instructions, when operating on the processor, cause the computing device to: process complex SAR data gathered using a first polarization; process complex SAR data gathered using a second polarization; store representations of both first and second polarization data; reconstruct the processed first polarization data using a reconstruction component; utilize the processed second polarization data as auxiliary information in the reconstruction component to influence the reconstruction of first polarization data; and generate modified or enhanced SAR data based on the processed representations of the first and second polarization data.

According to another preferred embodiment, a method for processing Synthetic Aperture Radar (SAR) data using cross polarization prediction, comprising the steps of: acquiring complex SAR data using both a first polarization process and a second polarization process; processing both first and second polarization data; storing representations of both first and second polarization data; reconstructing the processed first polarization data using a reconstruction component that utilizes the processed second polarization data as auxiliary information; and generating modified or enhanced SAR data based on the processed representations of the first and second polarization data.

According to an aspect of an embodiment, processing the complex SAR data comprises compressing the data using a compression algorithm.

According to an aspect of an embodiment, the compression algorithm is a neural network-based compression algorithm trained to efficiently compress both first and second polarization SAR data.

According to an aspect of an embodiment, the reconstruction component is a neural network trained to leverage correlations between the first and second polarizations for improved reconstruction accuracy.

According to an aspect of an embodiment, the computing device is further caused to: analyze the processed representations to extract features that are common or distinct between the first and second polarizations; and use the extracted features to enhance the reconstruction process or to derive additional information about the imaged scene.

According to an aspect of an embodiment, the computing device is further caused to: adapt the processing and reconstruction based on specific characteristics of the SAR data, including factors such as terrain type, incidence angle, and radar frequency.

According to an aspect of an embodiment, the first polarization is HH polarization and the second polarization is VV polarization.

According to an aspect of an embodiment, generating modified or enhanced SAR data comprises at least one of: interpolation between the first and second polarizations; extrapolation of polarization effects; and arithmetic operations on the processed representations.

### BRIEF DESCRIPTION OF THE DRAWING FIGURES

FIG. 1 is a block diagram illustrating an exemplary system architecture for compressing synthetic aperture radar (SAR) images, according to an embodiment.

FIG. 2 is a block diagram showing details of SAR subbands, according to an embodiment.

FIG. 3 is a block diagram illustrating details for subband-wise learning-based SAR image compression, according to an embodiment.

FIG. 4 illustrates formulas that may be used in an embodiment.

FIG. 5 is a flow diagram illustrating an exemplary method for compressing SAR image data, according to an embodiment.

FIG. 6 is a flow diagram illustrating an exemplary method for training a system for compressing and restoring telemetry data, according to an embodiment.

FIG. 7 is a drawing of an end-to-end architecture for SAR image compression, according to an embodiment.

FIG. 8 is a drawing of an architecture for neural learning for interferometric synthetic aperture radar phase recovery and unwrapping, according to an embodiment.

FIG. 9 is a flow diagram illustrating another exemplary method for compressing SAR image data, according to an embodiment.

FIG. 10 is a flow diagram illustrating an exemplary method for interferometric synthetic aperture radar phase recovery and unwrapping, according to an embodiment.

FIG. 11 is a flow diagram illustrating an exemplary method for training a system for compressing SAR image data using training data from an interferogram simulator, according to an embodiment.

FIG. 12 is a block diagram illustrating an exemplary aspect of the phase unwrapping system, according to an embodiment.

FIGS. 13A and 13B illustrate an exemplary architecture for an phase recovery network configured to provide phase unwrapping for a dual-channel data stream comprising SAR I/Q data, according to an embodiment.

FIG. 14 is a block diagram illustrating an exemplary architecture for a component of the system for SAR image compression, the channel-wise transformer fusion block.

FIG. 15 is a flow diagram illustrating an exemplary method for processing SAR data using enhanced phase recovery techniques, according to an embodiment.

FIG. 16 is a flow diagram illustrating an exemplary method for compressing SAR images with enhanced phase recovery and unwrapping, according to an embodiment.

FIG. 17 is a drawing of an end-to-end architecture for SAR image compression utilizing cross-polarization prediction, according to an embodiment.

FIG. 18 is a block diagram illustrating an exemplary aspect of an embodiment of a cross polarization prediction system, a decoder.

FIG. 19 is a block diagram illustrating another exemplary aspect of an embodiment of a cross polarization prediction system, a decoder.

FIG. 20 is a flow diagram illustrating an exemplary method for providing cross polarization prediction to produce enhanced, reconstructed SAR image data, according to an embodiment.

FIG. 21 illustrates an exemplary computing environment on which an embodiment described herein may be implemented, in full or in part.

The drawings are not necessarily to scale. The drawings are merely schematic representations, not intended to portray specific parameters of the disclosed embodiments. The drawings are intended to depict only typical embodiments of the invention, and therefore should not be considered as limiting in scope.

### DETAILED DESCRIPTION OF THE INVENTION

A system and method for processing SAR data using cross polarization prediction. The system processes complex SAR data from two different polarizations, typically HH and VV, and stores their representations. A specialized reconstruction component then reconstructs data from the first polarization while utilizing the second polarization data as auxiliary information. This cross-polarization approach enhances the reconstruction process, leveraging complementary information from both polarizations to produce improved SAR imagery. The method can employ neural network-based compression and reconstruction techniques, adaptive processing based on SAR data characteristics, and sophisticated analysis of cross-polarization relationships. Advanced implementations may include interpolation between polarizations, extrapolation of polarization effects, and arithmetic operations on processed representations to further enhance the SAR data. This innovation enables the generation of high-quality, information-rich SAR images with potential applications in environmental monitoring, urban planning, agriculture, and disaster response.

The implementation of this SAR image compression system with a focus on phase recovery and unwrapping begins with input processing. This step prepares the raw SAR data for efficient compression and accurate phase recovery. For instance, radiometric calibration ensures pixel values accurately represent radar backscatter, allowing consistent interpretation across different images and sensors. An example would be converting the raw digital numbers to radar cross-section values, enabling comparisons between images taken at different times or by different sensors. Geometric calibration corrects distortions caused by the SAR imaging geometry, ensuring accurate spatial relationships. This might involve correcting for terrain-induced distortions in mountainous areas. Speckle filtering reduces noise inherent in SAR images, improving overall image quality and facilitating better compression. A common technique here is the Lee filter, which can preserve edges while reducing speckle. Region of Interest (ROI) extraction can focus processing on critical areas, potentially reducing computational load and improving compression efficiency.

In some embodiments, the discrete cosine transform is applied and subbands are created. This transformation allows for more efficient compression by separating the image into different frequency components. For example, an 8×8 pixel block might be transformed into 64 DCT coefficients, representing different spatial frequencies. Creating subbands enables the system to treat different frequency ranges separately, which is beneficial because low and high frequency components often have different characteristics and importance in SAR images. The system might divide these into low frequency (LF) groups containing structural information and high frequency (HF) groups containing detail information.

Amplitude extraction follows, where amplitude information important for SAR image interpretation is preserved accurately. According to an embodiment, a two-pass compression allows for a more refined and accurate compression of amplitude information. For instance, the first pass might use a convolutional neural network to capture general amplitude characteristics, while the second pass employs a more complex network with residual connections to refine this information, potentially capturing more subtle details like small variations in surface roughness.

Phase extraction is then performed, as phase information is important for many SAR applications, especially in InSAR. Extracting phase separately allows for specialized processing tailored to the unique characteristics of phase data. For example, the system might extract the phase information from the complex SAR data and generate an interferogram, which visually represents the phase differences between two SAR images as a pattern of fringes.

According to some embodiments, the system then creates a latent space representation, allowing for more efficient compression and manipulation of the SAR data. The complex network structure (e.g., kernels, residual blocks, attention networks, etc.) captures and represents complex patterns and relationships in the data. For instance, a residual block might learn to represent typical phase patterns associated with certain terrain features, while an attention mechanism could focus on areas of significant phase change.

According to an embodiment, a channel-wise transformer fusion block (CTFB) is implemented to enhance the system's ability to process and fuse information across different channels and features. This allows for more complex interactions between different parts of the data, potentially capturing intricate relationships that simpler architectures might miss. For example, the CTFB might learn to correlate specific amplitude patterns with particular phase behaviors, improving overall reconstruction quality.

In some embodiments, a hyperprior latent feature summarization module enhances the compression and representation capabilities of the system. By creating a refined and disentangled representation, it allows for more efficient encoding of the most important features. For instance, it might learn to represent common SAR image features (like urban areas, forests, or water bodies) in a compact form, allowing for more efficient compression of these recurring patterns.

In some embodiments, a multi-stage context recovery subsystem is implemented, allowing for specialized treatment of different frequency components and optimization for both amplitude and phase. Different loss functions for LF and HF groups acknowledge that these components may require different optimization strategies. For example, the system might use a mean squared error loss for low-frequency components to preserve overall structure, while employing a perceptual loss for high-frequency components to maintain fine details.

A specialized phase unwrapping neural network can be useful for many SAR applications, particularly InSAR. This network can potentially overcome limitations of traditional phase unwrapping algorithms. For instance, it could learn to resolve phase ambiguities in areas of layover or shadow, which are challenging for conventional algorithms.

In an embodiment, arithmetic coding provides efficient lossless compression of the processed data. Using two separate subsystems allows for specialized encoding of the main latent representation and the hyperprior information, potentially leading to better overall compression. For example, one subsystem might be optimized for encoding the smooth variations typically found in the low-frequency components, while the other is tailored for the sparse, high-entropy data often present in the high-frequency components.

In an embodiment, the system can use an interferogram simulator for generation of diverse, controlled training data, which is often difficult to obtain for SAR applications. For instance, the simulator might generate synthetic interferograms representing various deformation patterns (e.g., volcanic uplift, earthquake displacements) to train the phase unwrapping network.

Performance optimization for specific hardware and performance targets is imagined for practical deployment. SAR applications often require real-time or near-real-time processing, hence the need for fast inference times. For example, the system might be optimized to process a 1024×1024 pixel SAR image in under 10 milliseconds on an NVIDIA RTX A6000 GPU.

Proper evaluation metrics are necessary to assess the system's performance and compare it with other methods. Using established metrics (PSNR, SQNR for amplitude; MAPE for phase) allows for standardized comparison. For instance, the system might achieve a PSNR of 35 dB for amplitude reconstruction and a MAPE of 0.1 radians for phase unwrapping, demonstrating its effectiveness compared to traditional methods.

Furthermore, bitstream generation and reconstruction creates the compressed representation and ensures it can be accurately reconstructed. Generating two separate bitstreams allows for more flexible and potentially more efficient encoding of different types of information. For example, one bitstream might contain the coarse, low-frequency information, while the other contains the fine details, allowing for progressive reconstruction where a rough version of the image can be quickly obtained before the full-resolution version is complete.

In the context of SAR images, HH and VV polarizations refer to specific configurations of how radar waves are transmitted and received. In HH polarization (H stands for horizontal), the radar wave is transmitted and received horizontally. This means both transmitted and received signals are in the same horizontal plane. In VV polarization (V stand for vertical), the radar wave is transmitted and received in the same vertical plane. These polarizations are important because they interact differently with various surfaces and objects on the ground, providing different types of information. For example, HH polarization is often better at penetrating vegetation canopies and is useful for detecting man-made structures, whereas VV polarization is generally more sensitive to surface roughness and can be useful for ocean and sea ice monitoring. SAR systems can also use cross-polarizations like HV (Horizontal transmit, Vertical receive) or VH (Vertical transmit, Horizontal receive), which can provide additional information about the scattering properties of the target. The choice of polarization in SAR imaging depends on the specific application and the type of information needed about the target area. Using multiple polarizations (called polarimetric SAR) can provide even more detailed information about the observed surfaces and objects.

SAR polarizations HH and VV exhibit complex relationships in the data they produce, with both correlations and distinct differences that provide valuable insights into surface characteristics. Generally, there's a positive correlation in backscatter intensity between HH and VV polarizations, meaning areas that appear bright or dark in one polarization often appear similarly in the other. However, this correlation isn't perfect and varies depending on the target being imaged.

The sensitivity of each polarization differs, with HH being more responsive to horizontal structures and double-bounce scattering, while VV is more attuned to vertical structures and surface scattering. This difference in sensitivity is important for applications like urban mapping or forest structure analysis. The radar's incidence angle also plays a role in the relationship between HH and VV data. At steeper angles (closer to looking straight down), the polarizations tend to correlate more strongly, but this correlation can decrease as the angle becomes more oblique.

Surface roughness significantly influences the relationship between HH and VV backscatter. Smooth surfaces typically yield stronger VV backscatter, but as roughness increases, the difference between HH and VV diminishes. This property is particularly useful in applications like soil moisture estimation or geological mapping. In vegetated areas, HH penetrates canopy cover more effectively than VV, leading to differences in backscatter that can be exploited for biomass estimation or crop monitoring.

Water bodies present another interesting case. Over oceans or lakes, VV generally produces stronger backscatter than HH. The ratio between HH and VV backscatter over water can be used to detect oil spills or estimate wind speeds, showcasing the importance of understanding these polarization relationships in environmental monitoring and disaster response.

Urban environments add another layer of complexity. HH and VV polarizations can show different sensitivities to building orientations and geometries, making the combination of both particularly powerful for urban planning and development monitoring. Seasonal changes, especially in agricultural areas, can alter the correlation between HH and VV due to variations in crop growth and soil moisture, highlighting the dynamic nature of these relationships.

It's worth noting that advanced SAR analysis often leverages both HH and VV polarizations, along with cross-polarizations (HV and VH), to derive polarimetric features. These features provide more comprehensive information about the imaged surface than any single polarization could offer. This multi-polarization approach has revolutionized fields like land cover classification, enabling more accurate and detailed mapping of complex environments.

Understanding these nuanced relationships between HH and VV polarizations is useful for effectively interpreting SAR data. It allows researchers and practitioners to extract maximum information from SAR images, leading to more accurate and insightful analyses across a wide range of applications, from agriculture and forestry to urban planning and disaster management.

A cross polarization prediction system presents an innovative approach to SAR image processing that combines data compression with cross-polarization reconstruction techniques. It operates by compressing complex SAR data collected using HH polarization, then employs a specialized network to reconstruct this compressed HH data using complex SAR data gathered from VV polarization as side information. The system leverages the inherent correlations between HH and VV polarizations to allow for efficient data handling while potentially preserving or even enhancing the information content of the reconstructed images. Such a system may be particularly valuable in scenarios where data transmission or storage capacity is limited, such as in satellite or airborne SAR systems with constrained downlink bandwidth. It might also be beneficial in situations where VV polarization data is more readily available or easier to transmit, yet HH polarization data is desired for specific analytical purposes. Furthermore, this approach could enable more flexible data collection strategies, allowing operators to prioritize one polarization for immediate transmission while still retaining the ability to reconstruct the other. Overall, the cross polarization prediction system represents a promising advancement in SAR data processing, potentially opening new avenues for applications in remote sensing, environmental monitoring, and earth observation.

One or more different aspects may be described in the present application. Further, for one or more of the aspects described herein, numerous alternative arrangements may be described; it should be appreciated that these are presented for illustrative purposes only and are not limiting of the aspects contained herein or the claims presented herein in any way. One or more of the arrangements may be widely applicable to numerous aspects, as may be readily apparent from the disclosure. In general, arrangements are described in sufficient detail to enable those skilled in the art to practice one or more of the aspects, and it should be appreciated that other arrangements may be utilized and that structural, logical, software, electrical and other changes may be made without departing from the scope of the particular aspects. Particular features of one or more of the aspects described herein may be described with reference to one or more particular aspects or figures that form a part of the present disclosure, and in which are shown, by way of illustration, specific arrangements of one or more of the aspects. It should be appreciated, however, that such features are not limited to usage in the one or more particular aspects or figures with reference to which they are described. The present disclosure is neither a literal description of all arrangements of one or more of the aspects nor a listing of features of one or more of the aspects that must be present in all arrangements.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible aspects and in order to more fully illustrate one or more aspects. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the aspects, and does not imply that the illustrated process is preferred. Also, steps are generally described once per aspect, but this does not mean they must occur once, or that they may only occur once each time a process, method, or algorithm is carried out or executed. Some steps may be omitted in some aspects or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other aspects need not include the device itself.

Techniques and mechanisms described or referenced herein will sometimes be described in singular form for clarity. However, it should be appreciated that particular aspects may include multiple iterations of a technique or multiple instantiations of a mechanism unless noted otherwise. Process descriptions or blocks in figures should be understood as representing subsystems, segments, or portions of code which include one or more executable instructions for implementing specific logical functions or steps in the process. Alternate implementations are included within the scope of various aspects in which, for example, functions may be executed out of order from that shown or discussed, including substantially concurrently or in reverse order, depending on the functionality involved, as would be understood by those having ordinary skill in the art.

### Definitions

The term “bit” refers to the smallest unit of information that can be stored or transmitted. It is in the form of a binary digit (either 0 or 1). In terms of hardware, the bit is represented as an electrical signal that is either off (representing 0) or on (representing 1).

The term “synthetic aperture radar” refers to an active remote sensing technique that combines data from multiple shorter acquisitions to simulate a larger antenna.

The term “neural network” refers to a computer system modeled after the network of neurons found in a human brain. The neural network is composed of interconnected nodes, called artificial neurons or units, that work together to process complex information.

The term “bitstream” refers to a binary sequence of data representing the compressed version of input data.

The term “autoencoder” refers to a type of neural network architecture that can learn compact representations of data.

### Conceptual Architecture

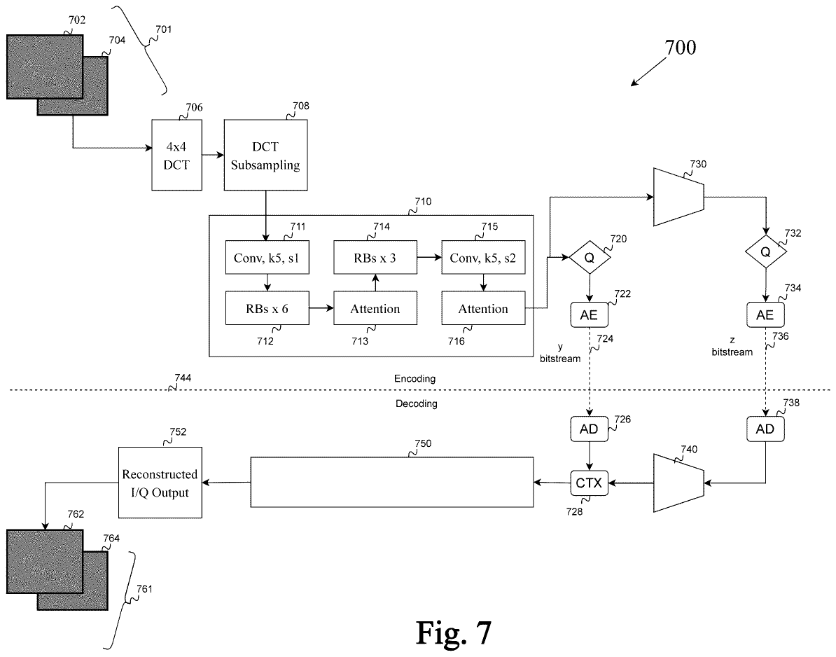

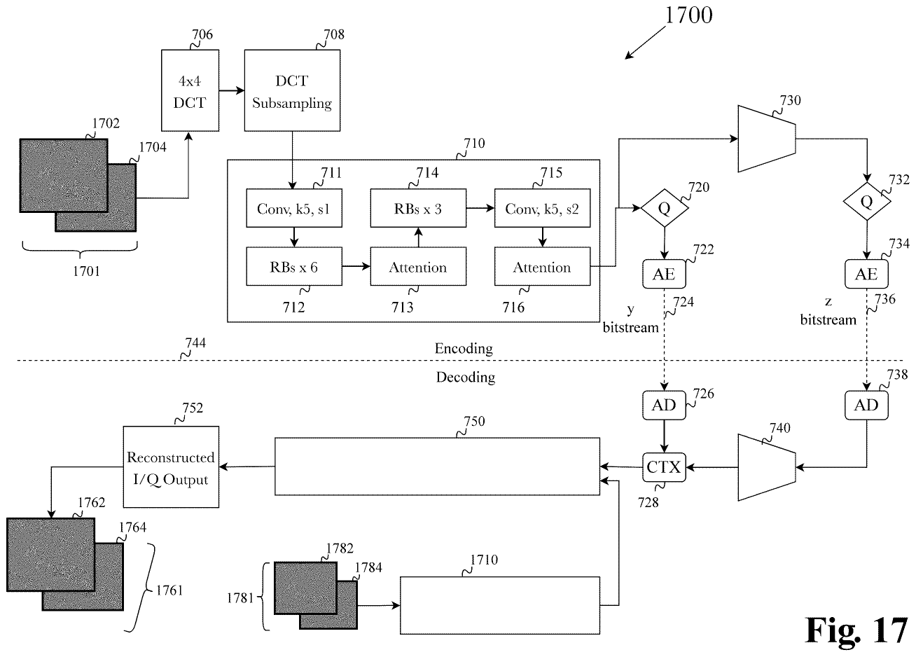

FIG. 17 is a drawing of an end-to-end architecture for SAR image compression utilizing cross-polarization prediction, according to an embodiment. According to an embodiment, the cross polarization prediction SAR image compression system leverages the correlations between and among at least a first and a second SAR dataset associated with a type of polarization to reconstruct a compressed representation of the first type of SAR image data. In this embodiment, the input data to the encoding portion of the cross polarization prediction system comprises original HH polarization SAR image 1701 comprising real 1702 and imaginary 1704 components, I/Q. The HH polarization SAR image input data 1701 is processed in the manner described in FIG. 7 to produce an encoded (compressed representation) of the HH SAR image data which may be represented by one or more compressed bit streams 724 and 736.

On the decoding side of the architecture, the compressed representation may be passed through a decoder network 750 which processes the compressed representation to output 752 reconstructed HH SAR image I/Q data 1761 comprising an in-phase component 1762 and a quadrature component 1764. To enable cross polarization prediction, decoder 750 may also receive as input, VV SAR image data 1781, comprising an in-phase component 1782 and a quadrature component 1784, which has been compressed using an encoder 1710. In an embodiment, the compressed VV SAR image data may be used as side information in decoder 750 which uses the correlations between HH and VV polarizations to generate (e.g., reconstruct) modified or enhanced SAR data based on the compressed representations of the HH data 1701 and VV data 1781. In an embodiment, encoders 1710 and 710 may comprise the same or similar components such that a first polarization (e.g., HH) and a second polarization (e.g., VV) are processed in the same or similar manner. According to an aspect, the processing of the first and second polarizations may comprise analyzing correlations between the two polarizations.

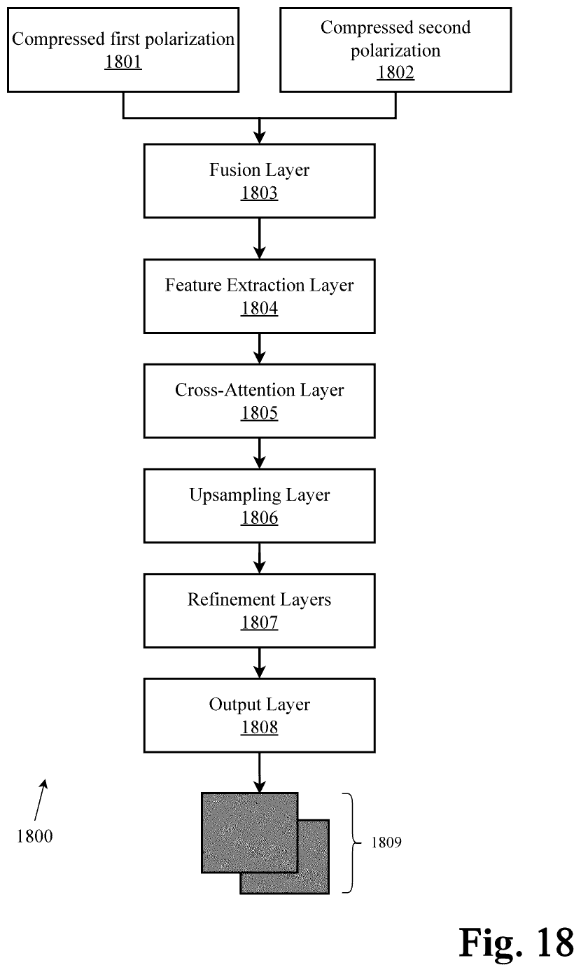

FIG. 18 is a block diagram illustrating an exemplary aspect of an embodiment of a cross polarization prediction system, a decoder. According to an embodiment, decoder may be implemented as a neural network model 1800 which utilizes deep learning techniques for model training and optimization. The exemplary decoder network architecture for the SAR compression system with cross polarization prediction is designed to effectively combine compressed data from two polarizations to reconstruct the first polarization data with enhanced quality. As shown, the network 1800 takes two inputs: the compressed first polarization data 1801 (e.g., HH) and the compressed second polarization data 1802 (e.g., VV). According to the embodiment, a fusion layer 1803 is present and configured to combine the two compressed polarization inputs. It may be implemented as a concatenation operation or a more sophisticated fusion mechanism such as gated fusion or attention-based fusion. In an embodiment, an embodiment of CFTB 1400 may be configured to operate in fusion layer 1803.

One or more feature extraction layer 1804 may be present and configured to process the fused data to extract relevant features from both polarizations. Feature extraction layers may be implemented as convolutional layers or transformer encoder layers, depending upon the embodiment. According to the aspect, a cross-attention layer 1805 may be implemented which allows the network to selectively focus on relevant information from the second polarization when reconstructing the first polarization. Following this, one or more upsampling layers 1806 progressively increase the spatial resolution of the data if it was reduced during compression. These could be implemented using transposed convolutions or pixel shuffle layers. The reconstructed data then goes through refinement layers 1807 for fine-tuning, potentially applying learned corrections or enhancements based on information from both polarizations. Finally, an output layer 1808 produces the reconstructed first polarization data 1809, matching the format and dimensions of the original uncompressed data.

As an example, consider a SAR image of an agricultural area, captured in both HH and VV polarizations. The original images are 1000×1000 pixels. After compression, each polarization is reduced to a 250×250 representation. Decoder network 1800 takes these compressed representations as input.
Input: Two 250×250 compressed representations (HH and VV)
Fusion: The network concatenates these inputs into a 250×250×2 tensor
Feature Extraction: Convolutional layers extract relevant features, producing a 250×250×64 tensor
Cross-Attention: This layer allows the HH reconstruction to focus on relevant VV features. For instance, it might emphasize VV information in areas with dense vegetation, where VV polarization typically provides better penetration
Upsampling: The network gradually increases the resolution back to 1000×1000
Refinement: Additional convolutional layers fine-tune the reconstruction, potentially enhancing edges or textures based on learned patterns from both polarizations
Output: The final layer produces a reconstructed 1000×1000 HH polarization image

In this example, the cross-polarization prediction might help recover details in the HH image that were lost during compression. For instance, it could enhance the definition of field boundaries or improve the detection of man-made structures by leveraging the complementary information provided by the VV polarization.

This architecture is flexible and can be adapted based on the specific characteristics of any given SAR dataset and compression method. It maintains end-to-end differentiability, allowing for joint training with the encoder if desired. In some embodiments, network 1800 comprises one or more residual connections between layers to facilitate gradient flow in deep networks. In some embodiments, network 1800 comprises one or more normalization layers (e.g., BatchNorm, LayerNorm, etc.) to stabilize training. According to an embodiment, activation layers such as ReLU or LeakyReLU may be implemented after each layer, except the output layer. According to an aspect of an embodiment, the network architecture further comprises a parallel branch that reconstructs the second polarization data, allowing for multi-task learning. According to an aspect of an embodiment, the network architecture incorporates a perceptual loss component that compares high-level features of the reconstructed and original data. According to an aspect of an embodiment, the network architecture implements a progressive growing strategy where the network starts with a low-resolution reconstruction and gradually increases resolution during training.

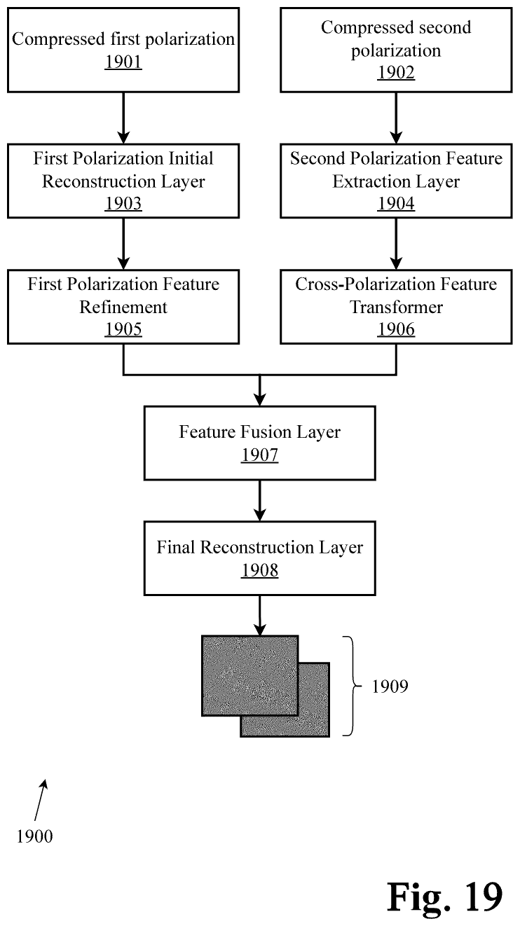

FIG. 19 is a block diagram illustrating another exemplary aspect of an embodiment of a cross polarization prediction system, a decoder 1900. This alternative embodiment of the decoder network architecture for a SAR compression system with cross polarization prediction employs parallel processing streams for each polarization, coupled with a late fusion strategy to combine the information for final reconstruction. The network begins with two separate input streams: one for the compressed first polarization 1901 (e.g., HH) and another for the compressed second polarization 1902 (e.g., VV), processing them independently at first. The compressed first polarization data undergoes an initial reconstruction stage 1903, comprising, for example, upsampling and convolutional layers that attempt to reconstruct the original polarization data without any information from the second polarization. Simultaneously, the compressed second polarization data goes through feature extraction 1902, distilling relevant information that might be useful for enhancing the first polarization reconstruction.

Following these initial stages, the partially reconstructed first polarization data undergoes further refinement 1905 to extract high-level features, while the extracted features from the second polarization are put through a cross-polarization feature transform 1906. This transform adapts the second polarization features to make them more directly applicable to enhancing the first polarization reconstruction. The refined first polarization features and the transformed second polarization features then converge at a feature fusion layer 1907, which intelligently combines the complementary information from both polarizations. Finally, the fused features pass through a series of final reconstruction layers 1908 that produce the fully reconstructed first polarization data 1909.

To illustrate this process, consider SAR images of a coastal area captured in both HH and VV polarizations. The original 2000×2000 pixel images are compressed to 500×500 representations for each polarization. In the parallel initial processing stage, the HH data is upsampled to 1000×1000, potentially recovering large-scale features like the coastline and major terrain variations. Concurrently, the VV data undergoes feature extraction, producing a 500×500×64 feature tensor capturing VV-specific information. During feature refinement and transform, the rough HH reconstruction is refined into a 1000×1000×32 feature tensor, possibly enhancing details like wave patterns or small coastal structures. The VV features undergo a cross-polarization transform, resulting in a 1000×1000×32 tensor that emphasizes VV features particularly useful for HH reconstruction, such as areas where VV provides better penetration of coastal vegetation.

These processed features then merge in the fusion layer, potentially using attention mechanisms to dynamically weight the importance of HH and VV information for different parts of the image. The fused tensor undergoes final reconstruction, upsampling to the full 2000×2000 resolution and refining details to produce the reconstructed HH polarization image. This approach may be particularly effective at preserving unique information from each polarization in a coastal scene. For instance, the HH polarization might better capture hard surfaces like buildings or ships, while the VV polarization could provide superior information about vegetation or soil moisture. By processing these in parallel and fusing later, the network can make nuanced decisions about combining this information for optimal reconstruction.

This architecture offers several potential advantages, including specialized processing of each polarization before fusion, preservation of more unique information from each polarization through the late fusion approach, and flexibility in how and when the cross-polarization information is incorporated.

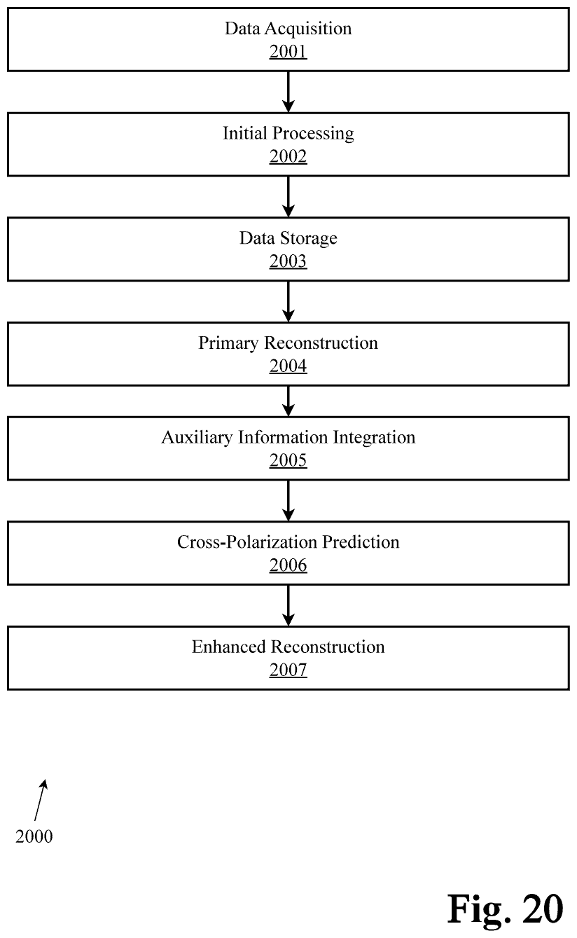

FIG. 20 is a flow diagram illustrating an exemplary method 2000 for providing cross polarization prediction to produce enhanced, reconstructed SAR image data, according to an embodiment. According to the embodiment, the process begins at step 2001 with the acquisition of complex SAR data using two distinct polarization processes. Typically, this involves gathering data using HH (horizontal transmit, horizontal receive) and VV (vertical transmit, vertical receive) polarizations, though other polarization combinations could be employed. Once acquired, both sets of polarization data undergo processing at step 2002, which may include compression, feature extraction, or other transformations designed to efficiently represent the SAR data while preserving critical information. The processed representations of both polarizations are then stored at step 2003, creating a compact yet informative representation of the original SAR scene.

At step 2004, the cross polarization prediction system provides primary reconstruction. Here, a specialized reconstruction component (e.g., decoder 1800, 1900) is employed to rebuild the first polarization data (e.g., HH). What sets this method apart is its innovative use of the processed second polarization data (e.g., VV) as auxiliary information during the reconstruction process. This reconstruction component, which could be implemented as a neural network or another advanced algorithm, is designed to leverage the complementary information present in the second polarization at step 2005. It may use techniques such as attention mechanisms, feature fusion, or adaptive filtering to intelligently incorporate relevant details from the second polarization into the reconstruction of the first.

The utilization of the second polarization data as auxiliary information allows the reconstruction component to make more informed decisions about how to interpret and enhance the first polarization data at step 2006. For instance, in areas where the first polarization may have weak returns or ambiguous features, the second polarization might provide crucial context or additional detail. This cross-polarization approach enables the reconstruction of features that might be poorly represented in a single polarization, leading to a more comprehensive and accurate representation of the imaged scene.

At step 2007 the method involves generating modified or enhanced SAR data based on the processed representations of both polarizations and the results of the cross-polarization reconstruction. This step may include further refinement of the reconstructed image, such as noise reduction, feature enhancement, or resolution improvement. The method may also incorporate techniques like interpolation between polarizations to simulate intermediate polarization states, extrapolation of polarization effects to predict SAR data for novel viewing geometries, or application of learned enhancements based on the relationship between the two polarizations. The result is a reconstructed SAR image that not only recovers the original first polarization data with high fidelity but also incorporates valuable information from the second polarization, producing an enhanced final product that leverages the strengths of both polarizations.

This method of cross polarization prediction for SAR image reconstruction offers several advantages over single-polarization approaches. It allows for more robust reconstruction in challenging imaging conditions, better preservation of fine details, and potentially the recovery of features that might be obscured or ambiguous in a single polarization. By exploiting the complementary nature of different polarizations, this method can produce SAR images with improved information content, potentially benefiting applications ranging from environmental monitoring and agricultural assessment to urban planning and disaster response.

The method for providing cross polarization prediction to produce enhanced, reconstructed SAR image data can be implemented with various additional features and techniques. In one implementation, the processing of complex SAR data for both the first and second polarizations involves compression using an identical compression algorithm. This approach ensures consistency in data handling and allows for efficient storage and transmission of the SAR data. The compression algorithm itself may be based on neural network techniques, specifically trained to efficiently compress both types of polarization data while preserving essential information unique to each.

The reconstruction component, central to the cross polarization prediction process, can be implemented as a neural network specially trained to leverage correlations between the first and second polarizations. This network might employ sophisticated architectures such as transformer models or custom-designed convolutional networks that are particularly adept at capturing and utilizing cross-polarization relationships. The training process for this network could involve a joint loss function that optimizes for both reconstruction accuracy and effective utilization of cross-polarization information.

An advanced implementation of the method might include an analysis step where the processed representations are examined to extract features that are common or distinct between the first and second polarizations. This analysis can yield valuable insights into the nature of the imaged scene and inform the reconstruction process. The extracted features may be used to enhance the reconstruction process itself or to derive additional information about the imaged scene, potentially offering new analytical capabilities beyond simple image reconstruction.

Flexibility and adaptability are key features that can be incorporated into the method. The processing and reconstruction steps can be designed to adapt based on specific characteristics of the SAR data, including factors such as terrain type, incidence angle, and radar frequency. This adaptive approach allows the method to optimize its performance across a wide range of imaging conditions and scene types, potentially improving the quality and reliability of the reconstructed data.

While the method is generally described using first and second polarizations, it's worth noting that these could specifically be HH and VV polarizations, respectively. This particular combination is widely used in SAR imaging and offers complementary information about many types of terrain and objects. However, the method could potentially be extended to other polarization combinations as well.

The generation of modified or enhanced SAR data, which is the final stage of the method, can incorporate several sophisticated techniques. These might include interpolation between the first and second polarizations to simulate intermediate polarization states, potentially offering insights into complex scattering behaviors. Extrapolation of polarization effects could be employed to predict SAR data for novel viewing geometries or radar configurations, expanding the utility of the collected data. Additionally, arithmetic operations on the processed representations could be used to enhance specific features or characteristics of the SAR data, tailoring the output to particular analytical needs.

Finally, the method can be extended to include steps for analyzing the processed representations to derive additional information about the imaged scene based on the relationships between the first and second polarization data. This could involve advanced machine learning techniques to classify land cover types, estimate physical parameters of the imaged surface, or detect changes over time when applied to multi-temporal datasets. By fully leveraging the complementary information provided by multiple polarizations, this enhanced analysis can extract maximum value from the SAR data, offering rich, multi-dimensional insights into the imaged environment.

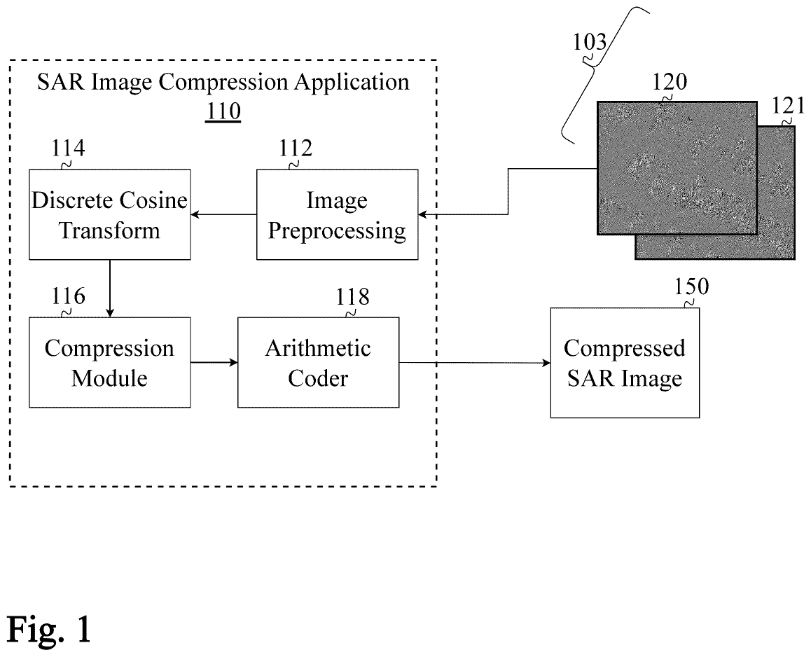

FIG. 1 is a block diagram illustrating an exemplary system architecture for compressing synthetic aperture radar (SAR) images, according to an embodiment. A SAR image 103 is input to the SAR image compression application 110. The SAR image 103 can include a first component 120 and a second component 121. In embodiments, the first component 120 comprises an amplitude component and the second component 121 comprises a phase component. The amplitude refers to the magnitude or strength of a signal. It can be represented as the absolute value of a complex signal. The phase represents the timing or position of the signal relative to a reference. In embodiments, the phase may be represented in units of degrees or radians. In one or more embodiments, the first component 120 comprises an in-phase (I) component, and the second component 121 comprises a quadrature (Q) component. The in-phase component represents the real part of a complex signal. The in-phase component corresponds to the amplitude of the signal when it is in phase with a reference. The quadrature component represents the imaginary part of the complex signal. The quadrature component corresponds to the amplitude of the signal when it is 90 degrees out of phase with the reference.

In one or more embodiments, one, or both of the components may be processed by the SAR image compression application 110. The SAR image compression application 110 can include an image preprocessing subsystem 112. The image processing subsystem can perform one or more operations on the first component 120 and/or second component 121. The preprocessing can include a radiometric calibration process to correct the SAR image for sensor-specific biases and noise, ensuring that the pixel values accurately represent the radar backscatter of the surface. The preprocessing can include a geometric calibration process to correct geometric distortions caused by the motion of the SAR imaging sensor and the Earth's curvature. The preprocessing can include noise reduction. The noise reduction can include speckle filtering to reduce speckle noise, which may be present in acquired SAR images due to the coherent nature of radar signals. In one or more embodiments, techniques including a Lee filter, Frost filter, and/or Gamma MAP filter may be used for the speckle filtering. The noise reduction can include median filtering to reduce noise while preserving edges and fine details. The preprocessing can include contrast enhancement to improve the visibility of features. In one or more embodiments, techniques including, but not limited to, histogram equalization and adaptive contrast enhancement are used to perform contrast enhancement. The preprocessing can include edge enhancement. In one or more embodiments, the edge enhancement can be implemented with techniques including, but not limited to, Sobel and/or Canny edge detectors. The preprocessing can include geocoding and/or georeferencing. The geocoding can include converting the SAR image coordinates to a standard map projection, aligning it with geographical coordinates. The georeferencing can include aligning the SAR image with a geographic coordinate system using ground control points (GCPs). Other preprocessing techniques may be used instead of, or in addition to, the aforementioned preprocessing operations.

The preprocessed image data is input to discrete cosine transform (DCT) subsystem 114. The Discrete Cosine Transform (DCT) is a mathematical technique well-suited for signal and image processing. The DCT represents an image as a sum of sinusoids with varying magnitudes and frequencies. The discrete cosine transform subsystem 114 is configured to compute the two-dimensional DCT of an image, capturing essential features. In embodiments, the input image is divided into blocks (e.g., 8-by-8 or 16-by-16), and a DCT is computed for each block, yielding coefficients that are used as part of the compression/decompression process. In embodiments, the discrete cosine transform subsystem 114 comprises programming instructions that when operating on the processor, cause the processor to perform a DCT operation on the quadrature component of the input SAR image, and create a second plurality of subbands for the quadrature component of the input SAR image.

The output of the discrete cosine transform (DCT) subsystem 114 is input to the compression subsystem 116. The compression subsystem 116 is configured to implement a latent feature learning block, wherein the latent feature learning block is configured and disposed to generate a latent space representation corresponding to the multiple groups of subbands. The compression subsystem may perform pixel unshuffling on the output of the discrete cosine transform (DCT) subsystem 114 to create one or more subbands. In embodiments, the subbands include a DC subband, and one or more AC subbands, where each AC subband represents a frequency range. In embodiments, a DC subband and 15 AC subbands are used, for a total of 16 subbands (i.e., 16 channels).

The compression subsystem 116 may further perform subband grouping. The subband grouping can include grouping subbands into a high frequency (HF) group, and one or more low frequency (LF) groups. In embodiments, the compression subsystem 116 groups the subbands into two low frequency groups (LF1, and LF2), and a high frequency group (HF). In one or more embodiments, one or more subbands may be discarded. In embodiments, the discarding includes discarding one or more subbands in the high frequency group, as those subbands often do not contain large amounts of meaningful information that is beneficial for SAR image analysis. Accordingly, discarding one or more subbands can help improve the compression ratio of SAR images. The compression subsystem 116 may further include a neural network to process each subband individually. The neural network can include an autoencoder, an implicit neural representation (INR), a deep learning neural network, and/or other suitable neural network. In embodiments, the compression subsystem 116 comprises programming instructions that when operating on the processor, cause the processor to discard one or more subbands prior to generating the latent space representation. In embodiments, the compression subsystem 116 further comprises programming instructions that when operating on the processor, cause the processor to implement a context network, wherein the context network is configured to compute a thumbnail version of the latent space representation. In embodiments, the compression subsystem further comprises programming instructions that when operating on the processor, cause the processor to implement a multi-stage context recovery subsystem, wherein the multi-stage context recovery subsystem comprises a first loss function associated with the first low frequency group, a second loss function associated with the second low frequency group, and a third loss function associated with the high frequency group. In embodiments, at least one of the first loss function, second loss function, and third loss function is based on a weighting scheme. In embodiments, at least one of the first loss function, second loss function, and third loss function is optimized for amplitude recovery. In embodiments, at least one of the first loss function, second loss function, and third loss function is optimized for phase recovery.

The output of the compression subsystem 116 can be input to arithmetic coder subsystem 118. In embodiments, the arithmetic coder subsystem 118 is configured to represent a string of characters using a single fractional number between 0.0 and 1.0. Frequently occurring symbols are stored with fewer bits, while rare symbols use more bits. In one or more embodiments, the arithmetic coder subsystem 118 can implement adaptive arithmetic coding, in which case the arithmetic coder subsystem 118 adapts to changing probabilities during the encoding process. The output of the arithmetic coder subsystem 118 can serve as a compressed SAR image 150. A compressed SAR image such as compressed SAR image 150 can be efficiently transmitted from a satellite or aircraft to a ground station, where it can then be decompressed using corresponding decompression techniques.

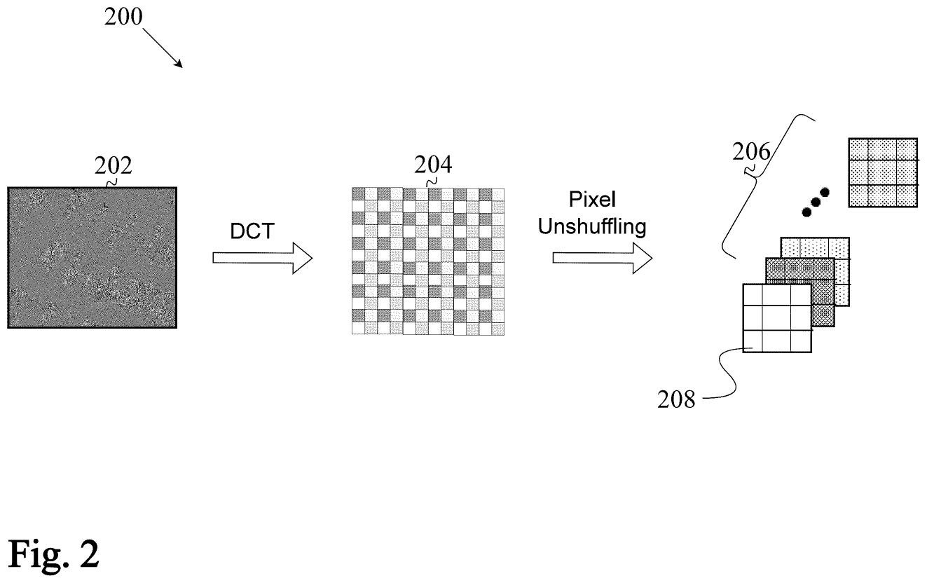

FIG. 2 is a block diagram 200 showing details of SAR subbands, according to an embodiment. In the diagram 200, an input SAR image 202 has a DCT process performed on it to create a DCT representation 204. The DCT representation 204 then may have a pixel unshuffling process performed on it, to create subband array 206, which includes multiple AC subbands, each representing a range of frequencies, and a DC subband, indicated as 208. The DCT representation 204 includes a set of coefficients that represent the frequency components of the input SAR image 202. These coefficients capture information about the image's spatial frequencies and help compress it efficiently. When the input SAR image 202 is divided into blocks (e.g., 8×8 or 16×16), each block undergoes DCT. The DCT coefficients may initially be arranged in a zigzag pattern within the block. Pixel unshuffling rearranges these coefficients into a linear order. This linear order facilitates efficient storage and transmission of the compressed data. In embodiments, the linear order is one of row-major or column-major.

In one or more embodiments, the SAR image 202 may be stored in a format such as GeoTIFF. The GeoTIFF format embeds georeferencing information within the image file, allowing the SAR data to be easily aligned with geographic coordinates. Other formats for storing/representing the SAR image 202 may include, but are not limited to, Hierarchical Data Format 5 (HDF5), CEOS (Committee on Earth Observation Satellites), NITF (National Imagery Transmission Format), and/or other suitable formats. The SAR data, stored in one of the aforementioned formats, and/or other suitable format, may be stored in a complex format, in which each pixel contains a complex number in the form of: (I+jQ). The real part of the complex data represents the In-phase component (I), and the imaginary part of the complex data represents the Quadrature component (Q). Tools such as Python along with the GDAL (Geospatial Data Abstraction Library) library, can be used to read a SAR image. A mathematical package such as NumPy may be used to extract the real and/or imaginary parts of the SAR image for data compression. Computations including magnitude and phase calculations may be performed in parallel on one or more subbands, thereby enabling efficient implementation on multi-core and/or multi-processor hardware.

Disclosed embodiments can utilize different neural networks to learn efficient latent representations of the subbands, with their own loss function that is adaptive to the subsequent recovery tasks, i.e., for amplitude or phase recovery. Embodiments can include using a different loss function and training strategy on a subband basis, or a subband group basis. Embodiments can include an 8×8 block wise decomposition, comprising multiple groups of subbands. In embodiments, there are three groups of subbands. In embodiments, a first group (Group 1) includes sorted index from 1 to 36, including predominantly DC and low frequency information, and thus, can be referred to as a Low Frequency (LF) group, while group 2 can include a sorted channel index from 37 to 48, that includes mainly higher frequency info for which is referred to as High Frequency (HF) group, while the third group for the remaining channels, are mainly imaging noise for which can be discarded to further improve compression efficiency. With this decomposition, instead of compression SAR images of H×W×2 resolution, the resulting output includes subbands of (H/8)×(W/8)×2 images that have more intra-group statistical similarity for effective learning. Furthermore, the loss function can be optimized subband wise, to different tasks like amplitude vs phase recovery.

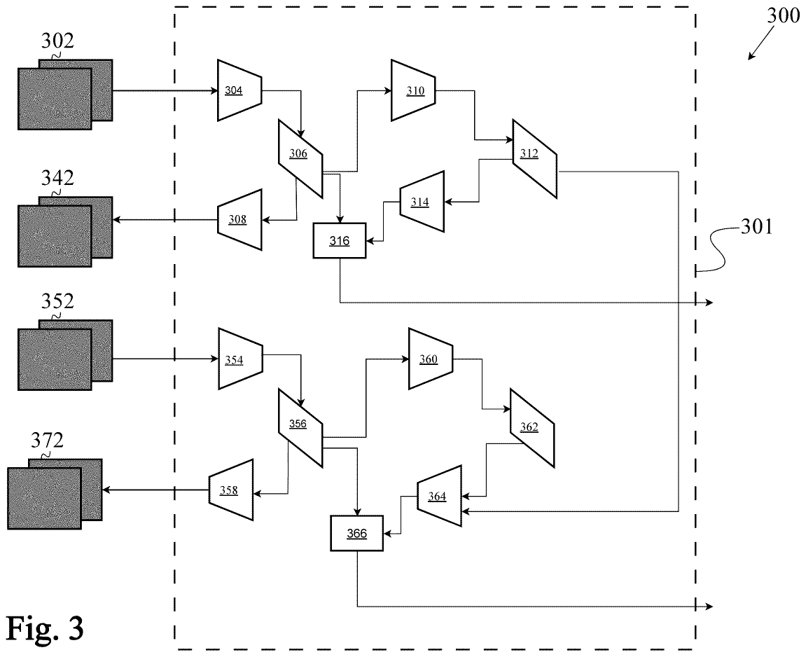

FIG. 3 is a block diagram 300 illustrating details for subband-wise learning-based SAR image compression, according to an embodiment. Block diagram 300 can represent a neural compact representation in which subband images are organized into LF and HF groups. For the LF group, the subbands can be further divided into LF1: {DC, AC1, AC2} and LF2, which includes the remaining AC subbands. Then a learning-based compression can be designed. The learning-based compression can include a latent feature learning block, which is equivalent to a transform, and then a context subsystem that codes context for an Arithmetic Coding (AC) engine.

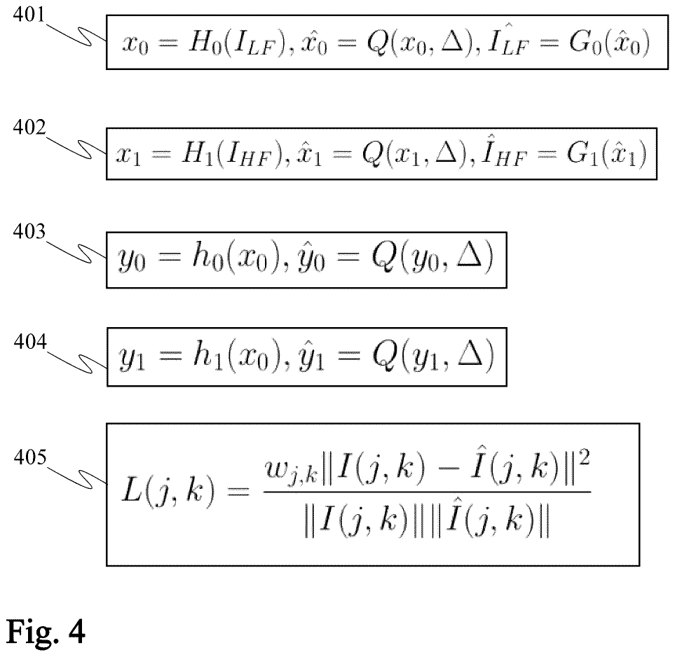

Input LF image components 302 are input to the neural compact representation 301 and is routed to block 304, which performs neural encoding to generate a latent representation, at block 306, at which point the input subbands of k channels of dimension (H/8)×(W/8)×2×k is I_{LF}, the neural encoder will give it a latent representation of x₀ of dimension h×w×N, as indicated in FIG. 4 at 401 and this is quantized and encoded with an arithmetic coder 316. Similarly, Input HF image components 352 are input to the neural compact representation 301 and is routed to block 354, which performs neural encoding to generate a latent representation, at block 356, at which point the input subbands of k channels of dimension (H/8)×(W/8)×2×k is I_{LF}, the neural encoder will give it a latent representation of x₁ of dimension h×w×N, as indicated in FIG. 4 at 402, and this is quantized and encoded with an arithmetic coder 366.

The flow of data continues from block 306 to block 308 which provides a latent feature representation subsystem, which outputs compressed LF image components 342, where the compressed LF image components 342 are compressed versions of input LF image components 302. Similarly, the flow of data continues from block 356 to block 358 which provides a latent feature representation subsystem, which outputs compressed HF image components 372, where the compressed HF image components 372 are compressed versions of input HF image components 352.

Additionally, the output of block 306 is provided to block 310 and arithmetic coder 316. The output of block 310 is routed to block 312, where a context y0 is computed, as indicated in FIG. 4 at 403. The output of block 312 is input to block 314 which in turn provides input to the arithmetic coder 316, which can provide an output that may be stored and/or transmitted. Similarly, the output of block 356 inputs to block 360, which inputs to block 362, where a context y1 is computed, as indicated in FIG. 4 at 404. The output of block 362 is routed to block 364, which inputs to arithmetic coder 366, which can provide an output that may be stored and/or transmitted. At the decoder side, the recovered latent feature will then be decoded back to the reconstructed subband images.

The same basic neural encoding and decoding is designed for the HF band. In one or more embodiments, a loss function L may be used. In embodiments, the loss function L is implemented on a subband basis, and can be regularized with different weighting scheme for amplitude and phase recovery separately. For amplitude recovery, L1 loss on subband images may be used, while for the phase recovery, a loss function that has a different amplitude weighted scheme may be employed in order to achieve optimal performance. Referring to FIG. 4, an exemplary loss function is indicated at 405, in which, (j, k) are indices to a pixel offset and band number in the subband images, and w_{j,k} is the weighting scheme that includes one or more hyperparameters to be optimized.

### Detailed Description of Exemplary Aspects

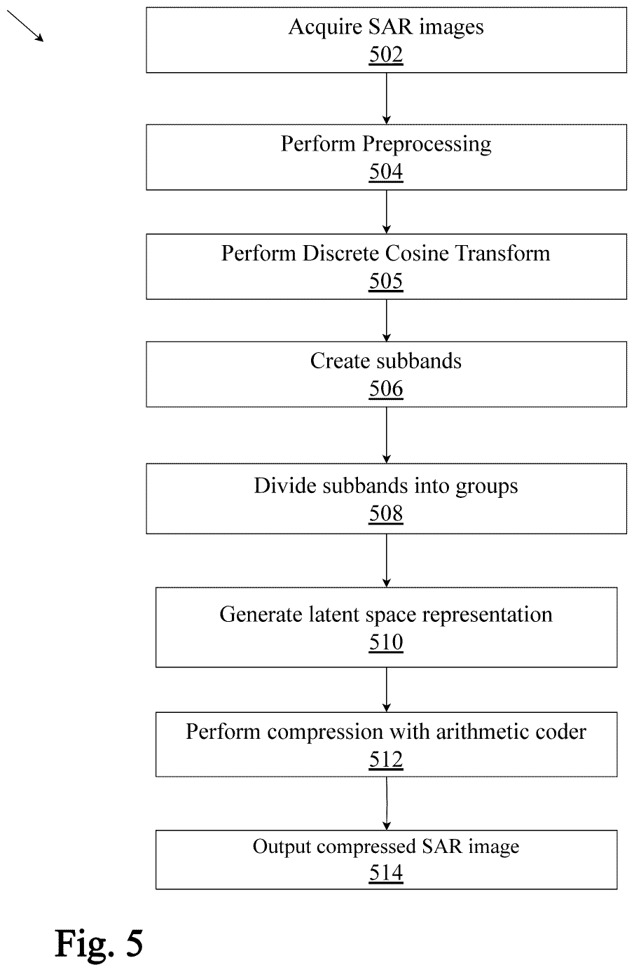

FIG. 5 is a flow diagram illustrating an exemplary method 500 for compressing SAR image data, according to an embodiment. At block 502, SAR images are acquired. In embodiments, the SAR images can be stored in a format that represents pixels as complex numbers. The method 500 continues to block 504, where preprocessing is performed. The preprocessing can include image enhancement, filtering, noise reduction, edge enhancement, region of interest (ROI) identification, and so on. Additionally, the preprocessing can include adding metadata to the image. The metadata can include geographic information, date and/or time information, and/or other relevant information. Thus, in embodiments, the one or more image preprocessing operations includes a radiometric calibration process. In embodiments, the one or more image preprocessing operations includes a geometric calibration process. In embodiments, the one or more image preprocessing operations includes a noise reduction process. In embodiments, the noise reduction process includes a speckle filtering process. In embodiments, the one or more image preprocessing operations includes a region of interest (ROI) extraction process.

The method 500 continues to block 505, where a discrete cosine transform is performed. The discrete cosine transform can include performing a block-wise tokenization scheme. In embodiments, the discrete cosine transform may be performed utilizing a Discrete Cosine Transform Deblur (DCTD) network. The method 500 continues to block 506, where a plurality of subbands is created. The subbands can include a DC component, as well as multiple AC components of varying frequency ranges. The method 500 continues to block 508, where the subband is divided into groups. In embodiments two or more groups may be created, including one or more low frequency (LF) groups, and one or more high frequency (HF) groups. The method 500 continues with generating a latent space representation 510. In one or more embodiments, the latent space representation may be generated by an autoencoder on a subband basis. Embodiments can include discarding one or more subbands prior to generating the latent space representation. Embodiments can include computing a thumbnail version of the latent space representation. In embodiments, the latent space representation can be generated by a variational autoencoder instead of, or in addition to, an autoencoder. Thus, disclosed embodiments can transform raw data that can include complex pixel values of a SAR image into a suitable internal representation or feature vector. The method 500 continues to block 512, where compression is performed with an arithmetic coder. The arithmetic coder can perform compression of latent space representations on a subband basis. The method 500 continues to block 514, where a compressed SAR image is output.

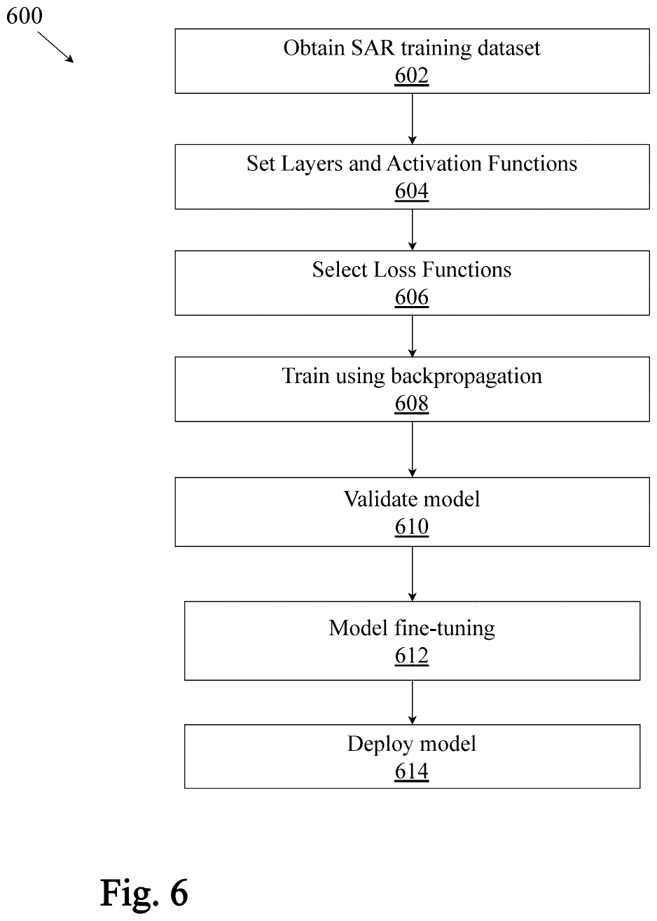

FIG. 6 is a flow diagram illustrating an exemplary method for training a system for compressing and restoring telemetry data, according to an embodiment. The method 600 starts with obtaining a SAR training dataset at block 602. The SAR training dataset can include multiple SAR images acquired under a variety of conditions. The method 600 continues with setting layers and activation functions at block 604. In a neural network, layers are the building blocks that form the structure of the network. Each layer consists of a collection of neurons (also called nodes or units), and each neuron performs a specific computation on the input data. The output of one layer becomes the input to the next layer, creating a series of transformations from the input to the output. The layers can include input layers, output layers, and/or hidden layers. The activation functions introduce non-linearity into the model, allowing it to learn and represent complex patterns in the data. In embodiments, the activation functions can include a sigmoid function, a hyperbolic tangent function, a rectified linear unit (ReLU), a Leaky ReLU, softmax function, and/or other suitable activation function. The method 600 continues to block 606 for selecting loss functions. The loss functions are mathematical functions used in machine learning to measure the difference between the predicted values produced by the model and the actual target values from the training data. In one or more embodiments, the loss functions can include Mean Squared Error (MSE), Mean Absolute Error (MAE), Categorical Cross-Entropy, and/or other suitable loss functions. The loss functions can be used to determine if the model is sufficiently trained. The method 600 continues to block 608 for training the model using backpropagation. The backpropagation process can include computing gradients of the loss with respect to the weights and biases in the output layer. These gradients are propagated backward through the neural network to the hidden layer. The method 600 continues to block 610, where the model is validated. The validation can include using an additional set of SAR images that were not part of the SAR training dataset as a test dataset. The test SAR images can be compressed, reconstructed, and the reconstructed SAR images can be compared with the original SAR test dataset to confirm proper operation of the model. The method 600 can include model fine-tuning at block 612. The model fine-tuning can include adjusting weights and/or other hyperparameters as needed to improve model output. The method 600 continues to block 614, where the model is deployed for use in satellites, aircraft, and/or other sources of SAR images. In this way, disclosed embodiments provide an efficient compression technique for compressing SAR images.

FIG. 7 is a drawing of an end-to-end architecture for SAR image compression, according to an embodiment. The architecture 700 receives as input, a SAR image 701 that includes an in-phase component 702 and a quadrature component 704. The SAR image data (702, 704) is input to a 4×4 DCT block 706. The output of the DCT block 706 is input to DCT subsampling module 708. The output of the DCT subsampling module 708 is input to a compression neural network 710. The compression neural network 710 can include multiple components. In the architecture 700, data input to the compression neural network 710 is routed to convolutional neural network 711. In one or more embodiments, the convolutional neural network 711 has a kernel size of five channels and a stride of 1. In one or more embodiments, the first kernel is configured to have five channels and a stride value of 1. The output of the convolutional neural network 711 is input to first residual block array 712. Residual block array 712 may include a plurality of residual blocks. In one or more embodiments, the first plurality of residual blocks comprises six residual blocks. In one or more embodiments, the residual blocks may be used to mitigate the vanishing gradient problem and improve training efficiency. In embodiments, the residual blocks may include one or more convolutional layers, batch normalization layers, and/or activation functions such as ReLU, softmax, sigmoid, swish, leaky ReLU, and/or other suitable activation functions.

The output of residual block array 712 is input to attention mechanism 713. The attention mechanism can include a query (Q) that represents a vector used to query the relevant information from the data, a key (K) that represents a vector that the query is compared against to determine relevance, and a value (V) that represents a vector containing the actual information or data to be used. In one or more embodiments, attention scores are generated, based on a dot product of the query and key vectors. The attention mechanism may also provide normalization, such as via a softmax function, or other suitable technique.

The output of the attention mechanism 713 is provided to a second residual block array 714. Residual block array 714 may include a plurality of residual blocks. In one or more embodiments, the second plurality of residual blocks comprises three residual blocks. The output of residual block array 714 is input to a second convolutional neural network 715. In one or more embodiments, the convolutional neural network 715 has a kernel size of five channels and a stride of 2. In one or more embodiments, the second kernel is configured to have five channels and a stride value of 2. The output of the convolutional neural network 715 is input to second attention network 716. The output of second attention network 716 can serve as the final stage of the compression neural network 710. The output of the compression neural network 710 can be input to a quantizer module 720. The output of the quantizer module 720 is input to arithmetic encoder 722, to create a first bitstream 724, referred to as the ‘y bitstream.’

Additionally, the output of the compression neural network 710 can be input to hyperprior latent feature summarization module 730. The hyperprior latent feature summarization module 730 can be used to implement a hierarchical Bayesian approach to improve the representation and disentanglement of latent features. The latent features can include compressed representations of data that capture essential characteristics of SAR images. The summarization can include extracting and representing the most important features from the latent space. The output of the hyperprior latent feature summarization module 730 can be input to a quantizer module 732. The output of the quantizer module 732 is input to arithmetic encoder 734, to create a second bitstream 736, referred to as the ‘z bitstream.’

The components illustrated above line 744 represent components used for encoding (compressing) SAR image data. The bitstream 724 and bitstream 736 may be transmitted via wireless protocols such as S-Band, X-Band, Ka-Band, C-band, Ku-Band, VHF, UHF, and/or other suitable wireless protocols. Additionally, the bitstream 724 and bitstream 736 may be transmitted via a variety of modulation schemes, including Phase Shift Keying protocols such as BPSK, QPSK, and/or 8PSK, Frequency Shift Keying (FSK), and/or other suitable modulation schemes.

Components shown below line 744 are used in decoding (decompressing) SAR image data. In one or more embodiments, the components above line 744 may reside at the source of SAR image data acquisition, such as in a satellite or aerial vehicle. In one or more embodiments, the components below line 744 may reside at a destination where the compressed SAR image data is received, such as a ground station. For decoding, the bitstream 724 is input to arithmetic decoder 726, while the bitstream 736 is input to arithmetic decoder 738. The output of the arithmetic decoder 726 is input to context model (CTX) 728. The context model 728 can perform grouping of latent features into distinct groups according to their energy. The context model 728 can serve to optimize the decoding process by enabling reuse of decoded latent feature elements in context modeling. The output of arithmetic decoder 738 is input to the hyperprior latent feature summarization module 740. The output of the hyperprior latent feature summarization module 740 is input to context model (CTX) 728. The output of context model 728 is input to decompression neural network 750 which may include components similar to those described for compression neural network 710, and trained for the task of decompression. The output of the decompression neural network 750 is reconstructed I/Q (in-phase/quadrature) output 752, which includes reconstructed SAR image 761 that comprises an in-phase component 762 and a quadrature component 764.

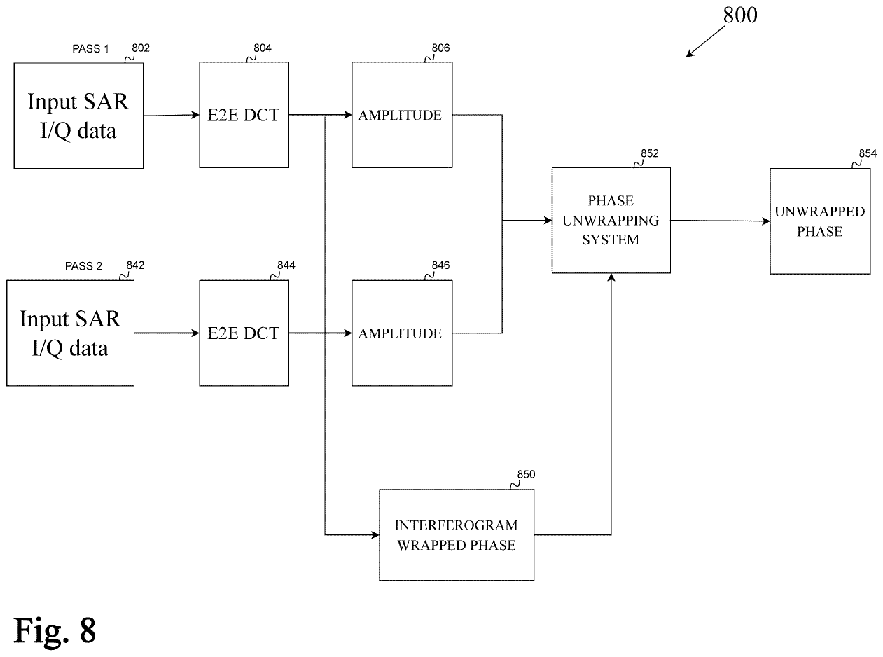

FIG. 8 is a drawing of an architecture 800 for neural learning for interferometric synthetic aperture radar phase recovery and unwrapping, according to an embodiment. Interferometric Synthetic Aperture Radar (InSAR) is a remote sensing technique used to measure ground deformation and surface changes. InSAR leverages the principles of radar interferometry. The SAR technique uses radar to create high-resolution images of the Earth's surface. SAR equipment sends out microwave signals and records the return signals (echoes) that bounce back from the surface. InSAR involves combining two or more SAR images taken from slightly different positions or times. By analyzing the phase differences between the signals, precise measurements of surface displacement can be made. One or more embodiments utilize the phase difference between radar signals. When two SAR images of the same area are captured, the differences in the phase of the returned signals can be analyzed. In embodiments, the phase information is used to generate an interferogram, which is a map showing the phase differences. These differences can indicate changes in elevation or ground movement. These features enable InSAR to support applications such as monitoring earthquakes, volcanic activity, land subsidence, and infrastructure stability.

Phase unwrapping is an important step in the processing of synthetic aperture radar images, particularly in InSAR applications. When SAR images are processed to measure surface deformation or topography, the phase information is often wrapped within a range of (−π) to (π). This wrapping occurs because the phase is measured modulo (2π), leading to discontinuities in the phase data. Disclosed embodiments enable phase unwrapping that can mitigate these discontinuities by adding the correct multiples of (2π) to the wrapped phase values. The unwrapping process reconstructs the continuous phase information, which is essential for accurate elevation measurements and deformation analysis.

The architecture 800 accepts a first pass (pass 1) of input SAR I/Q (in-phase and quadrature) data 802, and a second pass (pass 2) of input SAR I/Q (in-phase and quadrature) data 842. The input SAR I/Q data 802 is input to an end-to-end discrete cosine transform (DCT) process 804. Similarly, the input SAR I/Q data 842 is input to an end-to-end discrete cosine transform (DCT) process 844. The output of the end-to-end DCT process 804 is provided to an amplitude extraction process 806 that provides amplitude data of the first pass to phase unwrapping system 852. Similarly, the output of the end-to-end DCT process 844 is provided to an amplitude extraction process 846 that provides amplitude data of the second pass to phase unwrapping system 852. In one or more embodiments, the amplitude extraction process 846 and amplitude extraction process 806 may include computing a magnitude based on the in-phase component and the quadrature component using the Pythagorean theorem. The interferogram wrapped phase 850 from the input SAR data is also provided to the phase unwrapping system 852. The phase unwrapping system 852 then outputs unwrapped phase 854. The unwrapped phase 854 includes data that serves to resolve phase ambiguity, providing a continuous phase representation that reflects actual surface displacement.

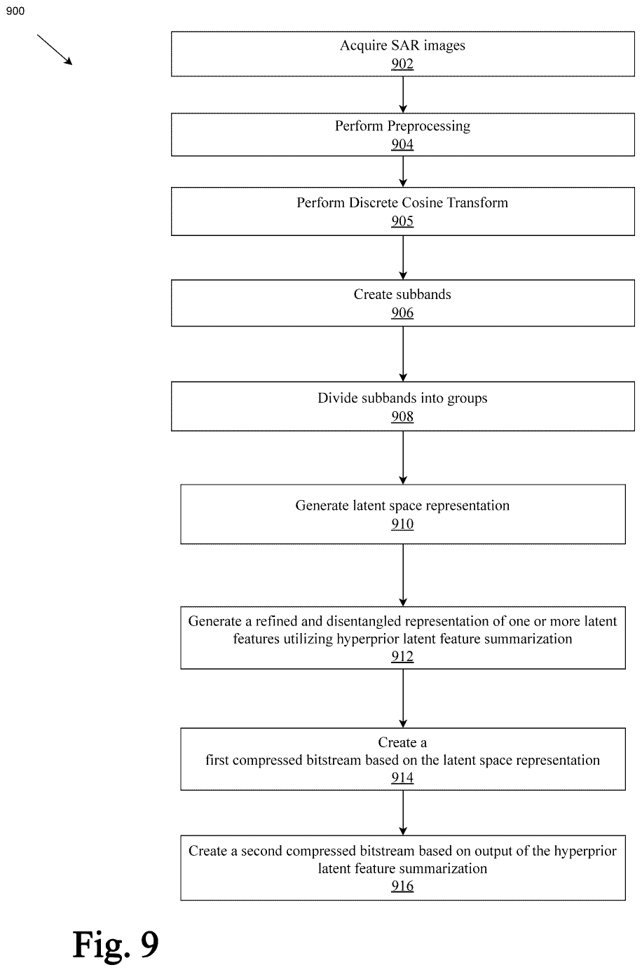

FIG. 9 is a flow diagram illustrating another exemplary method 900 for compressing SAR image data, according to an embodiment. At block 902, SAR images are acquired. In embodiments, the SAR images can be stored in a format that represents pixels as complex numbers. The method 900 continues to block 904, where preprocessing is performed. The preprocessing can include image enhancement, filtering, noise reduction, edge enhancement, region of interest (ROI) identification, and so on. Additionally, the preprocessing can include adding metadata to the image. The metadata can include geographic information, date and/or time information, and/or other relevant information. Thus, in embodiments, the one or more image preprocessing operations includes a radiometric calibration process. In embodiments, the one or more image preprocessing operations includes a geometric calibration process. In embodiments, the one or more image preprocessing operations includes a noise reduction process. In embodiments, the noise reduction process includes a speckle filtering process. In embodiments, the one or more image preprocessing operations includes a region of interest (ROI) extraction process.

The method 900 continues to block 905, where a discrete cosine transform is performed. The discrete cosine transform can include performing a block-wise tokenization scheme. In embodiments, the discrete cosine transform may be performed utilizing a Discrete Cosine Transform Deblur (DCTD) network. The method 900 continues to block 906, where a plurality of subbands is created. The subbands can include a DC component, as well as multiple AC components of varying frequency ranges. The method 900 continues to block 908, where the subband is divided into groups. In embodiments two or more groups may be created, including one or more low frequency (LF) groups, and one or more high frequency (HF) groups. The method 900 continues with generating a latent space representation 910. In one or more embodiments, the latent space representation may be generated by an autoencoder on a subband basis. Embodiments can include discarding one or more subbands prior to generating the latent space representation. Embodiments can include computing a thumbnail version of the latent space representation. In embodiments, the latent space representation can be generated by a variational autoencoder instead of, or in addition to, an autoencoder. Thus, disclosed embodiments can transform raw data that can include complex pixel values of a SAR image into a suitable internal representation or feature vector. The method 900 continues to block 912, where a refined and disentangled representation of one or more latent features are generated utilizing hyperprior latent feature summarization. The refined and disentangled representation provides latent features that each capture a distinct and independent factor of variation in the data, and can enable generative modeling. Moreover, the refined and disentangled representation of one or more latent features can serve as a form of noise reduction in that unnecessary or irrelevant information is minimized, leading to more robust models. Thus, the refined and disentangled representation can enable improved classification and regression results.

In one or more embodiments, the hyperprior latent feature summarization includes using a secondary latent variable (the hyperprior) to improve the modeling of uncertainty and dependencies in the primary latent features for SAR image data. In one or more embodiments, the hyperprior latent feature summarization module comprises a Hierarchical Bayesian Network (HBN). The HBN can include a top layer for representing hyperparameters and/or priors. The HBN can include a bottom layer that represents observed SAR image data. The HBN can include one or more middle layers for capture of intermediate latent variables. In one or more embodiments, the HBN may be implemented with multiple nodes that are connected by edges, that serve as directed links to indicate causal and/or dependency relationships between nodes.

The method 900 continues to block 914 where a first compressed bitstream based on the latent space representation is created. In one or more embodiments, an arithmetic encoder is used to create the compressed bitstream. The arithmetic encoder can be configured to estimate a probability of a given symbol, and encode frequently occurring symbols with a smaller representation. All symbols are processed, and the assigned value is converted to a binary representation which forms the compressed bitstream. The method 900 continues to block 916, where a second compressed bitstream based on the output of the hyperprior latent feature summarization is created. The second compressed bitstream may be created using an arithmetic encoder in a similar manner to that described for block 914.

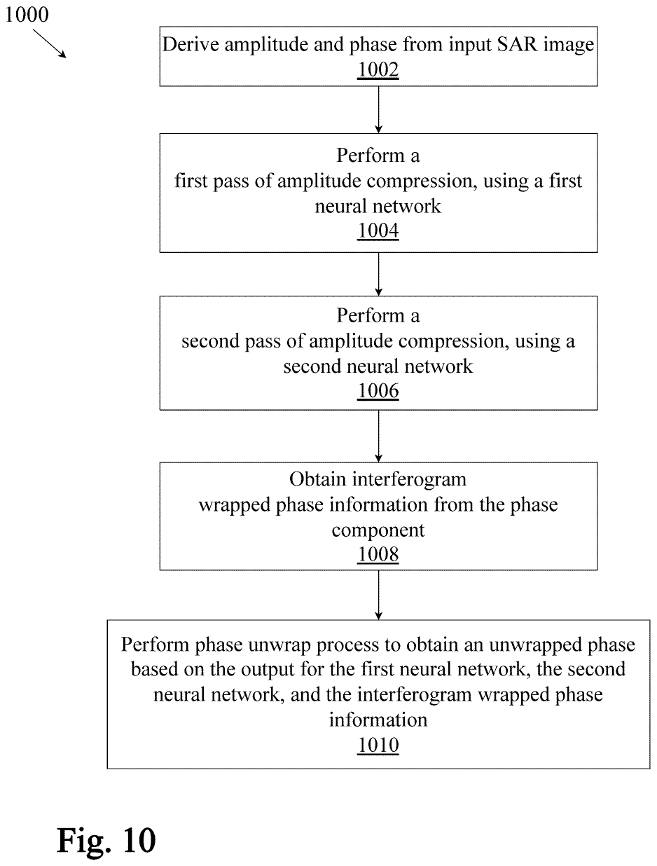

FIG. 10 is a flow diagram illustrating an exemplary method 1000 for interferometric synthetic aperture radar phase recovery and unwrapping, according to an embodiment. The method 1000 starts with deriving amplitude and phase from an input SAR image at block 1002. The method 1000 continues with performing a first pass of amplitude compression, using a first neural network at block 1004. The method 1000 continues with performing a second pass of amplitude compression, using a second neural network at block 1006. In one or more embodiments, the first pass and second pass may be performed sequentially. In one or more embodiments, the first pass and second pass may be performed concurrently. The method 1000 continues with obtaining interferogram wrapped phase information from the phase component at block 1008. The method 1000 continues with performing a phase unwrap process to obtain an unwrapped phase based on the output for the first neural network, the second neural network, and the interferogram wrapped phase information, at block 1010. Embodiments can include: deriving an amplitude component and a phase component from the input SAR image; performing a first pass of amplitude compression, using a first neural network; performing a second pass of amplitude compression, using a second neural network; obtaining interferogram wrapped phase information from the phase component; and performing a phase unwrap process to obtain an unwrapped phase based on the output for the first neural network, the second neural network, and the interferogram wrapped phase information.

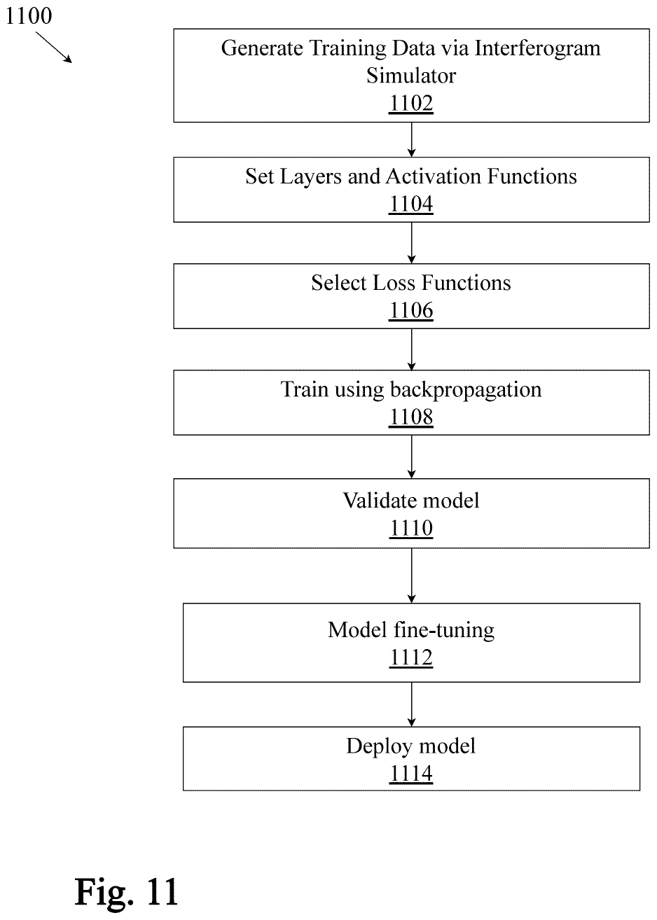

FIG. 11 is a flow diagram illustrating an exemplary method 1100 for training a system for compressing SAR image data using training data from an interferogram simulator, according to an embodiment. The method 1100 starts at block 1102 where training data is generated via an interferogram simulator. In one or more embodiments, the interferogram simulator can provide training samples with strong generalization ability for model training. Deep learning, as a data-driven method, requires a large number of training samples to train network models. In practice, it can be challenging to obtain ground truth corresponding to InSAR data because it is difficult to collect high-resolution ground deformation information, which limits the application of deep learning in the field of InSAR. In one or more embodiments, the interferogram simulator generates data based on phase characteristics of a large number of real interferograms, various statistical models of InSAR data, as well as noise sources, and generates training samples by simulating the phase components of terrain, buildings, deformation, noise, water surface and atmosphere. Thus, the interferogram simulator can be used in the training of neural networks for a variety of tasks, such as interferogram denoising, deformation detection and phase unwrapping, thereby enabling an improved training process for training neural networks to perform SAR image data compression and/or decompression.

The method 1100 continues with setting layers and activation functions at block 1104. In a neural network, layers are the building blocks that form the structure of the network. Each layer consists of a collection of neurons (also called nodes or units), and each neuron performs a specific computation on the input data. The output of one layer becomes the input to the next layer, creating a series of transformations from the input to the output. The layers can include input layers, output layers, and/or hidden layers. The activation functions introduce non-linearity into the model, allowing it to learn and represent complex patterns in the data. In embodiments, the activation functions can include a sigmoid function, a hyperbolic tangent function, a rectified linear unit (ReLU), a Leaky ReLU, softmax function, and/or other suitable activation function. The method 1100 continues to block 1106 for selecting loss functions. The loss functions are mathematical functions used in machine learning to measure the difference between the predicted values produced by the model and the actual target values from the training data. In one or more embodiments, the loss functions can include Mean Squared Error (MSE), Mean Absolute Error (MAE), Categorical Cross-Entropy, and/or other suitable loss functions. The loss functions can be used to determine if the model is sufficiently trained. The method 1100 continues to block 1108 for training the model using backpropagation. The backpropagation process can include computing gradients of the loss with respect to the weights and biases in the output layer. These gradients are propagated backward through the neural network to the hidden layer. The method 1100 continues to block 1110, where the model is validated. The validation can include using an additional set of SAR images that were not part of the SAR training dataset as a test dataset. The test SAR images can be compressed, reconstructed, and the reconstructed SAR images can be compared with the original SAR test dataset to confirm proper operation of the model. The method 1100 can include model fine-tuning at block 1112. The model fine-tuning can include adjusting weights and/or other hyperparameters as needed to improve model output. The method 1100 continues to block 1114, where the model is deployed for use in satellites, aircraft, and/or other sources of SAR images. In this way, disclosed embodiments provide an efficient compression technique for compressing SAR images.

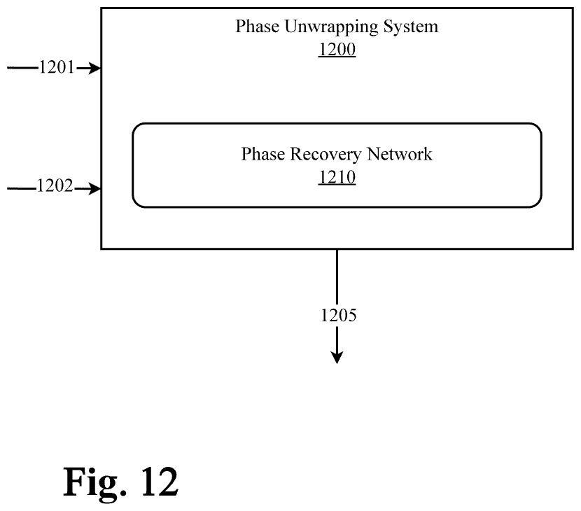

FIG. 12 is a block diagram illustrating an exemplary aspect of the phase unwrapping system, according to an embodiment. The systems and methods described herein may be further configured to support enhanced phase recovery during SAR image processing, such as data compression and/or decompression. An implementation for processing SAR data, leveraging the systems (FIG. 1 and FIG. 7) and components (FIGS. 8, 12, 13A and 13B, and 14) described herein, begins with receiving input SAR data, which typically contains complex-valued information including both amplitude and phase components. This data undergoes one or more preprocessing operations, which may include calibration to ensure accuracy, filtering to reduce noise, or selection of specific regions of interest. The preprocessed SAR data is then transformed into an alternative representation, which could be a frequency domain representation or another suitable format that facilitates efficient processing. A multi-stage processing technique is applied, utilizing one or more machine learning models to analyze and manipulate the SAR data. This stage may involve sequential application of different models, each focusing on specific aspects of the data. Concurrently, phase information is extracted from the input SAR data for specialized processing. An information fusion mechanism is employed to integrate different components of the SAR data, potentially using neural network-based feature integration to capture complex relationships within the data. A dedicated phase processing model (e.g., phase recovery network 1210) then utilizes both the processed amplitude information and the extracted phase information to produce enhanced phase data, which may involve tasks such as phase unwrapping, noise reduction, or error correction. A recovery subsystem is implemented with one or more optimization functions, which may be tailored to different components of the SAR data, ensuring comprehensive data recovery. The processed SAR data is then used to generate at least one compressed representation, potentially creating multiple data streams to efficiently represent different aspects of the data. The entire system, including the machine learning models and other trainable components, is jointly optimized using a combined optimization function. Finally, SAR information is reconstructed from the compressed representation, now featuring enhanced characteristics that improve its utility for various applications.

As an example, consider a scenario where SAR data is collected for monitoring coastal erosion. The input data is a series of complex-valued SAR images covering a 50 km stretch of coastline, captured over a period of six months. In the preprocessing stage, radiometric calibration is applied to ensure consistent interpretation across the time series, and a speckle filter reduces noise. The data is then transformed into a wavelet domain representation, which effectively separates different spatial scales of the coastal features. The multi-stage processing begins with a convolutional neural network that identifies large-scale coastal structures, followed by a transformer network that focuses on fine-scale changes in beach morphology. Phase information is extracted and used to generate interferograms between consecutive acquisitions. The information fusion mechanism, implemented as a graph neural network, integrates features from both the amplitude and phase data, capturing the relationship between physical structures and their changes over time. The phase processing model, trained on coastal environments, takes the processed amplitude data and interferograms as inputs and produces enhanced phase maps, correctly resolving phase ambiguities in areas of complex coastal geometry and accounting for atmospheric effects. The recovery subsystem applies different optimization functions to the onshore and offshore components of the data, with a weighted scheme favoring the preservation of shoreline features. Multiple compressed data streams are generated: one representing the main structural information, another for fine-scale changes, and a third for the phase information. The system, optimized for a distributed computing environment, processes this six-month dataset in under an hour. Upon reconstruction, the processed SAR data shows enhanced coherence between acquisitions and improved definition of coastal features. The resulting dataset, with its enhanced characteristics, allows coastal scientists to accurately measure subtle changes in shoreline position and beach volume, while requiring only 15% of the original data size for storage and transmission. This processed data enables more accurate predictions of future coastal erosion trends, aiding in coastal management and planning.

According to the embodiment, phase unwrapping system 1200 comprises one or more phase recovery networks 1210 (also referred to herein as phase unwrapping network). According to an embodiment, the phase unwrapping network is a specialized deep neural network designed to address one of the most challenging aspects of InSAR processing: resolving phase ambiguities. Its architecture may combine convolutional layers, residual connections, and attention mechanisms, possibly incorporating elements of a channel-wise transformer fusion block (CTFB) to fuse information across different channels and capture long-range dependencies in the data, which is particularly important for understanding global phase patterns. In an embodiment, the network takes two inputs: compressed amplitude information 1201 from a two-pass compression process and interferogram wrapped phase information 1202. This dual input allows the network to leverage both amplitude and phase information for more accurate unwrapping. The network's output 1205 is unwrapped phase data, resolving the 2π ambiguities inherent in wrapped phase information. In an embodiment, training is conducted using simulated interferograms, allowing for a wide variety of scenarios and ground truth data that would be difficult to obtain from real-world measurements alone. In an implementation, a specialized loss function may be used, incorporating both phase accuracy and spatial consistency metrics. In an embodiment, phase error metrics can comprise mean phase error metrics (MAPE). In an embodiment, MAPE may be defined as:

$$MAPE [ i ] = \frac{1}{M} {\sum }_{M} \vert PE [ m ] \vert$$

$$PE [ i ] = ∠ x [ i ] - ∠ y [ i ]$$

This phase unwrapping network represents a significant advancement over the existing systems and methods by addressing a critical aspect of SAR data processing that wasn't specifically covered before. It provides a dedicated solution for one of the most critical and challenging aspects of InSAR processing, integrating compressed amplitude information alongside the wrapped phase to leverage correlations that traditional unwrapping algorithms might miss. The learning-based approach allows the network to potentially handle complex terrains or noisy data more effectively than traditional algorithms. The network can be fine-tuned for specific types of terrain or SAR systems, and once trained, it can process large SAR datasets very quickly. By training on a wide variety of simulated data, the network can potentially handle a broader range of real-world scenarios more robustly than traditional algorithms. The phase unwrapping may integrated into the overall compression and reconstruction pipeline (e.g., such as the pipeline shown in FIG. 7), allowing for end-to-end optimization of the entire process. As more data becomes available or as simulation techniques improve, the network can be retrained or fine-tuned for even better performance, making the overall system much more valuable for applications that rely heavily on accurate phase information.

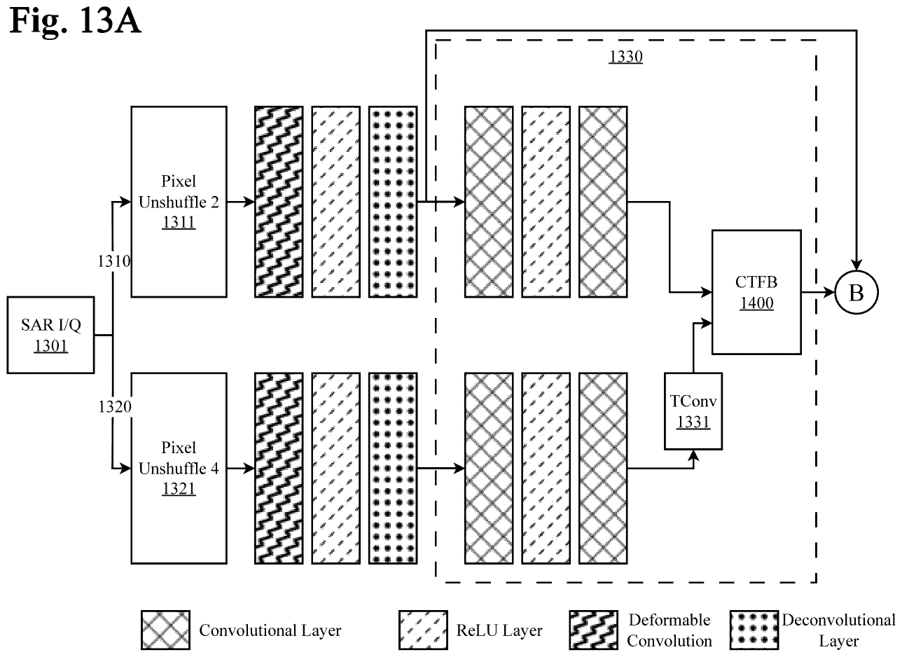

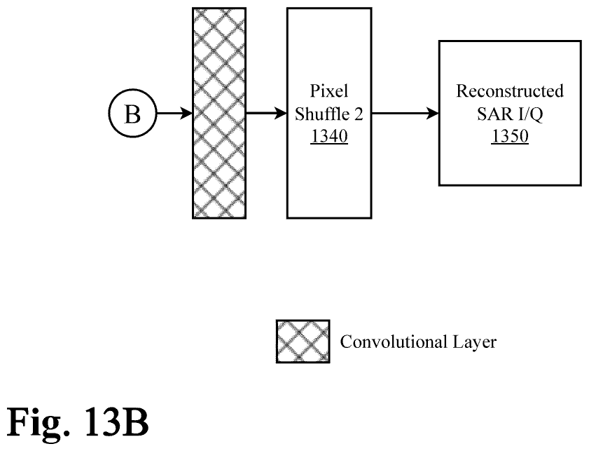

FIGS. 13A and 13B illustrate an exemplary architecture for an phase recovery network configured to provide phase unwrapping for a dual-channel data stream comprising SAR I/Q data, according to an embodiment. In the context of this disclosure, dual-channel data refers to fact that SAR image signal can be represented as two (dual) components (i.e., I and Q) which are correlated to each other in some manner. In the case of I and Q, their correlation is that they can be transformed into phase and amplitude information and vice versa. Phase recovery network utilizes a deep learned neural network architecture for joint frequency and pixel domain learning. According to the embodiment, a network may be developed for joint learning across one or more domains. As shown, the top branch 1310 is associated with a first domain and the bottom branch 220 is associated with a second domain. In an embodiment, the first domain is associated with a pixel domain and the second domain is associated with a frequency domain. In an embodiment, the first domain is associated with a multi-pass compressed amplitude domain and the second domain is associated with an interferogram wrapped phase domain. According to the embodiment, the phase recovery network receives as input complex-valued SAR image I and Q channels 1301 which, having been encoded via an encoding mechanism, has subsequently been decompressed via a decoding mechanism before being passed to phase recovery network or image enhancement via artifact removal. Inspired by the residual learning network and the MSAB attention mechanism, phase recovery network employs resblocks that take two inputs. In some implementations, to reduce complexity the spatial resolution may be downsampled to one-half and one-fourth. During the final reconstruction the data may be upsampled to its original resolution. In one implementation, in addition to downsampling, the network employs deformable convolution to extract initial features, which are then passed to the resblocks. In an embodiment, the network comprises one or more resblocks and one or more convolutional filters. In an embodiment, the network comprises 8 resblocks and 64 convolutional filters.

Deformable convolution is a type of convolutional operation that introduces spatial deformations to the standard convolutional grid, allowing the convolutional kernel to adaptively sample input features based on the learned offsets. It's a technique designed to enhance the modeling of spatial relationships and adapt to object deformations in computer vision tasks. In traditional convolutional operations, the kernel's positions are fixed and aligned on a regular grid across the input feature map. This fixed grid can limit the ability of the convolutional layer to capture complex transformations, non-rigid deformations, and variations in object appearance. Deformable convolution aims to address this limitation by introducing the concept of spatial deformations. Deformable convolution has been particularly effective in tasks like object detection and semantic segmentation, where capturing object deformations and accurately localizing object boundaries are important. By allowing the convolutional kernels to adaptively sample input features from different positions based on learned offsets, deformable convolution can improve the model's ability to handle complex and diverse visual patterns.

According to an embodiment, the network may be trained as a two stage process, each utilizing specific loss functions. During the first stage, a mean squared error (MSE) function is used in the I/Q domain as a primary loss function for the AI deblocking network. The loss function of the SAR I/Q channel L_{SAR} is defined as:

$${L}_{SAR} = 𝔼 [ {‖ I - {I}_{amp} ‖}_{2} ]$$

Moving to the second stage, the network reconstructs the amplitude component and computes the amplitude loss using MSE as follows:

$${L}_{amp} = 𝔼 [ {‖ {I}_{amp} - {I}_{dec , amp} ‖}_{2} ]$$

To calculate the overall loss, the network combines the SAR loss and the amplitude loss, incorporating a weighting factor, α, for the amplitude loss. The total loss is computed as:

$${L}_{total} = {L}_{SAR} + α \times {L}_{amp}$$

The weighting factor value may be selected based on the dataset used during network training. In an embodiment, the network may be trained using two different SAR datasets: the National Geospatial-Intelligence Agency (NGA) SAR dataset and the Sandia National Laboratories Mini SAR Complex Imagery dataset, both of which feature complex-valued SAR images. In an embodiment, the weighting factor is set to 0.0001 for the NGA dataset and 0.00005 for the Sandia dataset. By integrating both the SAR and amplitude losses in the total loss function, the system effectively guides the training process to simultaneously address the removal of the artifacts and maintain the fidelity of the amplitude information. The weighting factor, a, enables phase recovery network to balance the importance of the SAR loss and the amplitude loss, ensuring comprehensive optimization of the network during the training stages. In some implementations, diverse data augmentation techniques may be used to enhance the variety of training data. For example, techniques such as horizontal and vertical flops and rotations may be implemented on the training dataset. In an embodiment, model optimization is performed using MSE loss and Adam optimizer with a learning rate initially set to 1×10⁻⁴ and decreased by a factor of 2 at epochs 100, 200, and 250, with a total of 300 epochs. In an implementation, the batch size is set to 256×256 with each batch containing 16 images.

Both branches first pass through a pixel unshuffling layer 1311, 1321 which implements a pixel unshuffling process on the input data. Pixel unshuffling is a process used in image processing to reconstruct a high-resolution image from a low-resolution image by rearranging or “unshuffling” the pixels. The process can involve the following steps, low-resolution input, pixel arrangement, interpolation, and enhancement. The input to the pixel unshuffling algorithm is a low-resolution image (i.e., decompressed, quantized SAR I/Q data). This image is typically obtained by downscaling a higher-resolution image such as during the encoding process executed by an encoder. Pixel unshuffling aims to estimate the original high-resolution pixel values by redistributing and interpolating the low-resolution pixel values. The unshuffling process may involve performing interpolation techniques, such as nearest-neighbor, bilinear, or more sophisticated methods like bicubic or Lanczos interpolation, to estimate the missing pixel values and generate a higher-resolution image.

The output of the unshuffling layers 1311, 1321 may be fed into a series of layers which can include one or more convolutional layers and one or more rectified linear unit (ReLU) layers. A legend is depicted for both FIG. 13A and FIG. 13B which indicates the cross hatched block represents a convolutional layer, the dashed block represents a ReLU layer, the zig-zag block represents deformable convolution layers, and the dotted block represents deconvolutional layers. A deformable convolution is the first layer to extract features from an input image. Convolution preserves the relationship between pixels by learning image features using small squares of input data. It is a mathematical operation that takes two inputs such as an image matrix and a filter or kernel. The filter size associated with each convolutional layer may be different. The filter size used for the first domain of the top branch may be different than the filter size used for the second domain of the bottom branch.

A ReLU layer is an activation function used in neural networks. In other implementations, other non-linear functions such as tanh or sigmoid can be used instead of ReLU.

After passing through a series of convolutional and ReLU layers, both branches enter the channel-wise transformer network 1330 which further comprises more convolutional and ReLU layers. The second domain branch is slightly different than the pixel domain branch once inside 1330, specifically the second domain is processed by a transposed convolutional (TConv) layer 1331. Transposed convolutions are a type of operation used in neural networks for tasks like image generation, image segmentation, and upsampling. They are used to increase the spatial resolution of feature maps while maintaining the learned relationships between features. Transposed convolutions aim to increase spatial dimensions of feature maps, effectively “upsampling” them. This is typically done by inserting zeros (or other values) between existing values to create more space for new values.

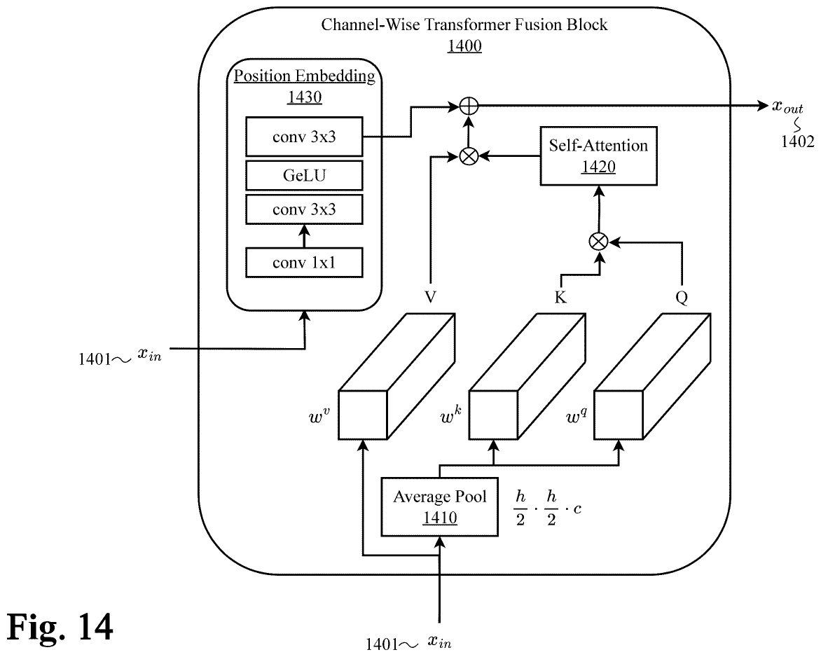

Inside 1330 the data associated with the first and second domains are combined back into a single stream by using the output of the Tconv 1331 and the output of the top branch. The combined data may be used as input for a channel-wise transformer fusion block (CTFB) 1400. In some embodiments, the CTFB may be implemented as a multi-scale attention block utilizing the attention mechanism. For more detailed information about the architecture and functionality of channel-wise transformer 1400 refer to FIG. 14. The output of CTFB 1400 may be a bit stream suitable for reconstructing the original SAR I/Q image. FIG. 14B shows the output of 1330 is passed through a final convolutional layer before being processed by a pixel shuffle layer 1340 which can perform upsampling on the data prior to image reconstruction. In some implementations, the output of the phase recovery network may be passed through a quantizer for dequantization prior to producing a reconstructed SAR I/Q image 2130.

In an embodiment, the phase recovery network consists of several key components working together to effectively unwrap phase information from SAR interferograms. The input layer receives compressed amplitude information and interferogram wrapped phase data, allowing the network to leverage correlations between amplitude and phase. Convolutional layers then apply filters to extract local features, detecting edges, textures, and other spatial patterns relevant to phase unwrapping. Residual blocks with skip connections enable training of deeper networks and help maintain gradient flow, important for learning complex phase relationships. According to an embodiment, CTFB 1400 includes self-attention mechanisms and position embeddings to fuse information across different channels and capture long-range dependencies in the data. Additional attention mechanisms calculate weights to focus on the most relevant parts of the input, helping the network prioritize important areas for unwrapping, such as regions with rapid phase changes.

Upsampling layers increase the spatial resolution of the feature maps to restore the unwrapped phase to the original resolution of the SAR image. The output layer produces the final unwrapped phase map, generating a continuous phase field without 2π ambiguities. A loss function component computes the difference between the network's output and the ground truth unwrapped phase, guiding the training process to minimize errors. An optimization component updates the network weights based on the computed loss, improving performance over time during training. Finally, an interferogram simulator interface generates diverse training data with known ground truth, providing a wide range of scenarios for training, including challenging cases that might be rare in real-world data. This integrated approach leverages both spatial and channel-wise relationships in the data, handles multi-scale features, and learns to prioritize important regions for accurate unwrapping, aiming to overcome limitations of traditional phase unwrapping methods, especially in complex terrain or noisy conditions.

FIG. 14 is a block diagram illustrating an exemplary architecture for a component of the system for SAR image compression, the channel-wise transformer fusion block 1400. According to the embodiment, channel-wise transformer receives an input signal, xᵢₙ 1401, the input signal comprising SAR I/Q data (and/or compressed amplitude and interferometric wrapped phase) which is being processed by phase recovery network 1210. The input signal may be copied and follow two paths through CTFB 1400. The I and Q channels go through separate feature embedding at different scales. CTFB 1400 controls Q, K dimension via pooling to allow more fusion blocks to fuse the separate I and Q channels.

A first path may process input data through a position embedding module 1430 comprising series of convolutional layers as well as a Gaussian Error Linear Unit (GeLU). In traditional recurrent neural networks or convolutional neural networks, the order of input elements is inherently encoded through the sequential or spatial nature of these architectures. However, in transformer-based models, where the attention mechanism allows for non-sequential relationships between tokens, the order of tokens needs to be explicitly conveyed to the model. Position embedding module 1430 may represent a feedforward neural network (position-wise feedforward layers) configured to add position embeddings to the input data to convey the spatial location or arrangement of pixels in an image. The output of position embedding module 1430 may be added to the output of the other processing path the received input signal is processed through.

A second path may process the input data. It may first be processed via a channel-wise configuration and then through a self-attention layer 1420. The signal may be copied/duplicated such that a copy of the received signal is passed through an average pool layer 1410 which can perform a downsampling operation on the input signal. It may be used to reduce the spatial dimensions (e.g., width and height) of feature maps while retaining the most important information. Average pooling functions by dividing the input feature map into non-overlapping rectangular or square regions (often referred to as pooling windows or filters) and replacing each region with the average of the values within that region. This functions to downsample the input by summarizing the information within each pooling window.

Self-attention layer 1420 may be configured to provide an attention to phase recovery network 1210. The self-attention mechanism, also known as intra-attention or scaled dot-product attention, is a fundamental building block used in various deep learning models, particularly in transformer-based models. It plays a crucial role in capturing contextual relationships between different elements in a sequence or set of data, making it highly effective for tasks involving sequential or structured data like complex-valued SAR I/Q channels. Self-attention layer 1420 allows each element in the input sequence to consider other elements and weigh their importance based on their relevance to the current element. This enables the model to capture dependencies between elements regardless of their positional distance, which is a limitation in traditional sequential models like RNNs and LSTMs.

The input 1401 and downsampled input sequence is transformed into three different representations: Query (Q), Key (K), and Value (V). These transformations (w^{V}, w^{K}, and w^{Q}) are typically linear projections of the original input. For each element in the sequence, the dot product between its Query and the Keys of all other elements is computed. The dot products are scaled by a factor to control the magnitude of the attention scores. The resulting scores may be normalized using a softmax function to get attention weights that represent the importance of each element to the current element. The Values (V) of all elements are combined using the attention weights as coefficients. This produces a weighted sum, where elements with higher attention weights contribute more to the final representation of the current element. The weighted sum is the output of the self-attention mechanism for the current element. This output captures contextual information from the entire input sequence.

The output of the two paths (i.e., position embedding module 1430 and self-attention layer 1420) may be combined into a single output data stream xₒᵤₜ 1402.

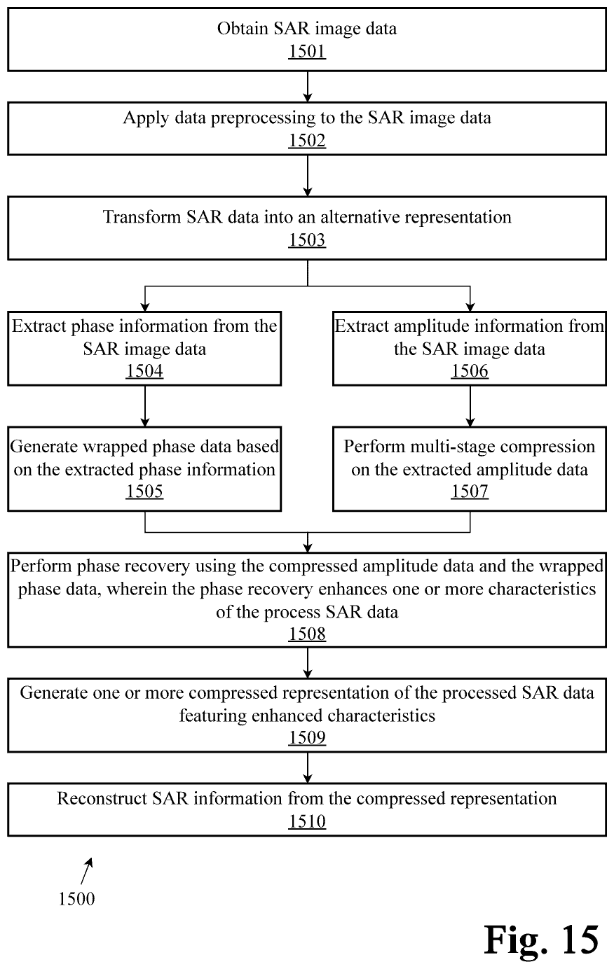

FIG. 15 is a flow diagram illustrating an exemplary method 1500 for processing SAR data using enhanced phase recovery techniques, according to an embodiment. According to the embodiment, the process begins at step 1501 with receiving input SAR data, which typically contains complex-valued information including both amplitude and phase components. This data undergoes one or more preprocessing operations at step 1502, which may comprise calibration to ensure accuracy, filtering to reduce noise, or selection of specific regions of interest. The preprocessed SAR data is then transformed into an alternative representation at step 1503, which could be a frequency domain representation or another suitable format that facilitates efficient processing. According to an embodiment, a multi-stage processing technique is applied, utilizing one or more machine learning models to analyze and manipulate the SAR data. This stage may involve sequential application of different models, each focusing on specific aspects of the data. In an embodiment, the multi-stage processing technique comprises a dual-pass compression on extracted amplitude data. At step 1504, phase information is extracted from the input SAR data for specialized processing. The specialized processing may comprise generating wrapped phase data at step 1505. In an embodiment, the wrapped phase data is interferometric wrapped phase data. An information fusion mechanism may be implemented to integrate different components of the SAR data, potentially using neural network-based feature integration to capture complex relationships within the data. At step 1506, amplitude information is extracted from the SAR image data, and multi-stage processing is applied to compress the amplitude data at step 1507. At step 1508 at dedicated phase processing model (e.g., phase recovery network 1210) then utilizes both the processed amplitude information and the extracted phase information to produce enhanced phase data, which may involve tasks such as phase unwrapping, noise reduction, or error correction. A recovery subsystem is implemented with one or more optimization functions, which may be tailored to different components of the SAR data, ensuring comprehensive data recovery. At step 1509 the processed SAR data is then used to generate at least one compressed representation, potentially creating multiple data streams to efficiently represent different aspects of the data. The entire system, including the machine learning models and other trainable components, may be jointly optimized using a combined optimization function. At step 1510, SAR information is reconstructed from the compressed representation, now featuring enhanced characteristics that improve its utility for various applications.

As an example, consider a scenario where SAR data is collected for monitoring coastal erosion. The input data is a series of complex-valued SAR images covering a 50 km stretch of coastline, captured over a period of six months. In the preprocessing stage, radiometric calibration is applied to ensure consistent interpretation across the time series, and a speckle filter reduces noise. The data is then transformed into a wavelet domain representation, which effectively separates different spatial scales of the coastal features. The multi-stage processing begins with a convolutional neural network that identifies large-scale coastal structures, followed by a transformer network that focuses on fine-scale changes in beach morphology. Phase information is extracted and used to generate interferograms between consecutive acquisitions. The information fusion mechanism, implemented as a graph neural network, integrates features from both the amplitude and phase data, capturing the relationship between physical structures and their changes over time. The phase processing model, trained on coastal environments, takes the processed amplitude data and interferograms as inputs and produces enhanced phase maps, correctly resolving phase ambiguities in areas of complex coastal geometry and accounting for atmospheric effects. The recovery subsystem applies different optimization functions to the onshore and offshore components of the data, with a weighted scheme favoring the preservation of shoreline features. Multiple compressed data streams are generated: one representing the main structural information, another for fine-scale changes, and a third for the phase information. The system, optimized for a distributed computing environment, rapidly processes this six-month dataset. Upon reconstruction, the processed SAR data shows enhanced coherence between acquisitions and improved definition of coastal features. The resulting dataset, with its enhanced characteristics, allows coastal scientists to accurately measure subtle changes in shoreline position and beach volume, while requiring only 15% of the original data size for storage and transmission. This processed data enables more accurate predictions of future coastal erosion trends, aiding in coastal management and planning.

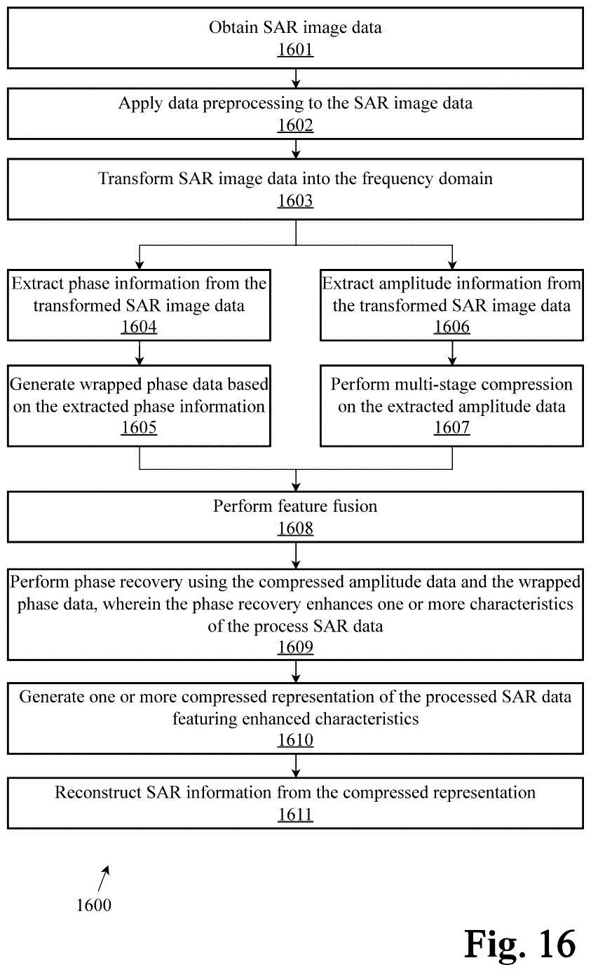

FIG. 16 is a flow diagram illustrating an exemplary method 1600 for compressing SAR images with enhanced phase recovery and unwrapping, according to an embodiment. According to the embodiment, the process for compressing SAR images with enhanced phase recovery and unwrapping begins at step 1601 with receiving an input SAR image comprising complex-valued data, typically consisting of in-phase and quadrature components. At step 1602 the image undergoes preprocessing operations, which may include radiometric calibration, geometric calibration, speckle filtering, or region of interest extraction, to prepare it for further processing. At step 1603 the preprocessed image is then transformed into a frequency domain representation, often using a discrete cosine transform, which separates the image into different frequency components (e.g., LF and HF components). Amplitude information may be extracted from the SAR image data at step 1606. A multi-stage compression technique is applied to process the amplitude information at step 1607, utilizing one or more neural networks for initial and refined compression. At step 1604, phase information is extracted from the input SAR image. At step 1605, the extracted phase information may be used to generate wrapped phase data. A feature fusion mechanism, such as a channel-wise transformer fusion block, is employed to enhance information integration across different components of the SAR image data at step 1608. A specialized phase processing neural network then utilizes both the compressed amplitude information and the extracted phase information to produce processed phase data at step 1609, which may include phase unwrapping. A context recovery step may be implemented with loss functions optimized for both amplitude and phase recovery, ensuring the preservation of important information. The processed SAR image data is then used to generate one or more compressed representations at step 1610, which may comprise creating separate bitstreams for latent space representation and hyperprior latent feature summarization. The entire system, including the neural networks and other trainable components, can be jointly trained using a combined loss function that optimizes both amplitude and phase recovery. At step 1611, the SAR image is reconstructed from the compressed representation, now featuring enhanced phase information.

As an example, consider a SAR image of a mountainous region, captured for the purpose of monitoring geological changes. The input image is a 1024×1024 pixel complex-valued dataset. In the preprocessing stage, radiometric calibration is applied to ensure accurate backscatter representation, and a speckle filter reduces noise. The image is then transformed using DCT, creating 64 subbands. The multi-stage compression begins with a convolutional neural network performing initial amplitude compression, followed by a residual network for refinement. Meanwhile, the phase information is extracted and an interferogram is generated. The CTFB then fuses features from both amplitude and phase data. The phase processing neural network, trained on various terrain types, takes the compressed amplitude and interferogram as inputs and produces an unwrapped phase map, correctly resolving phase ambiguities in areas of steep terrain. The context recovery subsystem applies different loss functions to low and high-frequency components, with a weighted scheme favoring the preservation of geologically significant features. Two compressed bitstreams are generated: one representing the main latent space and another for the hyperprior information. The system, optimized for GPU processing (e.g., optimized for an NVIDIA A100 GPU), processes this image in milliseconds. Upon reconstruction, the image shows a PSNR of 32 dB for amplitude and a MAPE of 0.15 radians for phase. The resulting compressed SAR image, with its enhanced phase information, allows geologists to accurately measure subtle terrain deformations, potentially indicating geological activity, while requiring only 20% of the original data size for storage and transmission.

### Exemplary Computing Environment

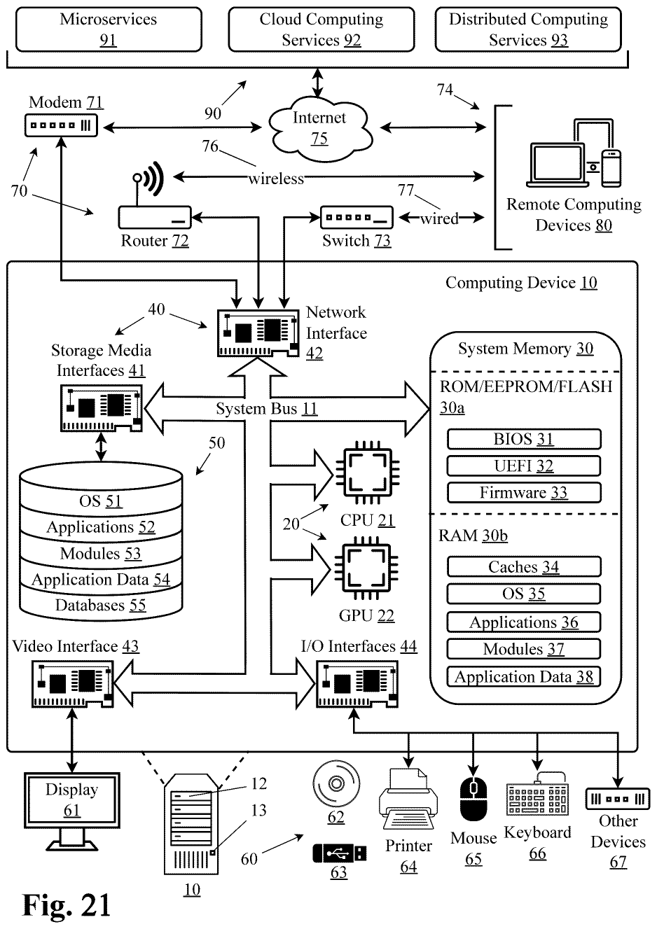

FIG. 21 illustrates an exemplary computing environment on which an embodiment described herein may be implemented, in full or in part. This exemplary computing environment describes computer-related components and processes supporting enabling disclosure of computer-implemented embodiments. Inclusion in this exemplary computing environment of well-known processes and computer components, if any, is not a suggestion or admission that any embodiment is no more than an aggregation of such processes or components. Rather, implementation of an embodiment using processes and components described in this exemplary computing environment will involve programming or configuration of such processes and components resulting in a machine specially programmed or configured for such implementation. The exemplary computing environment described herein is only one example of such an environment and other configurations of the components and processes are possible, including other relationships between and among components, and/or absence of some processes or components described. Further, the exemplary computing environment described herein is not intended to suggest any limitation as to the scope of use or functionality of any embodiment implemented, in whole or in part, on components or processes described herein.

The exemplary computing environment described herein comprises a computing device 10 (further comprising a system bus 11, one or more processors 20, a system memory 30, one or more interfaces 40, one or more non-volatile data storage devices 50), external peripherals and accessories 60, external communication devices 70, remote computing devices 80, and cloud-based services 90.

System bus 11 couples the various system components, coordinating operation of and data transmission between those various system components. System bus 11 represents one or more of any type or combination of types of wired or wireless bus structures including, but not limited to, memory busses or memory controllers, point-to-point connections, switching fabrics, peripheral busses, accelerated graphics ports, and local busses using any of a variety of bus architectures. By way of example, such architectures include, but are not limited to, Industry Standard Architecture (ISA) busses, Micro Channel Architecture (MCA) busses, Enhanced ISA (EISA) busses, Video Electronics Standards Association (VESA) local busses, a Peripheral Component Interconnects (PCI) busses also known as a Mezzanine busses, or any selection of, or combination of, such busses. Depending on the specific physical implementation, one or more of the processors 20, system memory 30 and other components of the computing device 10 can be physically co-located or integrated into a single physical component, such as on a single chip. In such a case, some or all of system bus 11 can be electrical pathways within a single chip structure.

Computing device may further comprise externally-accessible data input and storage devices 12 such as compact disc read-only memory (CD-ROM) drives, digital versatile discs (DVD), or other optical disc storage for reading and/or writing optical discs 62; magnetic cassettes, magnetic tape, magnetic disk storage, or other magnetic storage devices; or any other medium which can be used to store the desired content and which can be accessed by the computing device 10. Computing device may further comprise externally-accessible data ports or connections 12 such as serial ports, parallel ports, universal serial bus (USB) ports, and infrared ports and/or transmitter/receivers. Computing device may further comprise hardware for wireless communication with external devices such as IEEE 1394 (“Firewire”) interfaces, IEEE 802.11 wireless interfaces, BLUETOOTH® wireless interfaces, and so forth. Such ports and interfaces may be used to connect any number of external peripherals and accessories 60 such as visual displays, monitors, and touch-sensitive screens 61, USB solid state memory data storage drives (commonly known as “flash drives” or “thumb drives”) 63, printers 64, pointers and manipulators such as mice 65, keyboards 66, and other devices 67 such as joysticks and gaming pads, touchpads, additional displays and monitors, and external hard drives (whether solid state or disc-based), microphones, speakers, cameras, and optical scanners.

Processors 20 are logic circuitry capable of receiving programming instructions and processing (or executing) those instructions to perform computer operations such as retrieving data, storing data, and performing mathematical calculations. Processors 20 are not limited by the materials from which they are formed or the processing mechanisms employed therein, but are typically comprised of semiconductor materials into which many transistors are formed together into logic gates on a chip (i.e., an integrated circuit or IC). The term processor includes any device capable of receiving and processing instructions including, but not limited to, processors operating on the basis of quantum computing, optical computing, mechanical computing (e.g., using nanotechnology entities to transfer data), and so forth. Depending on configuration, computing device 10 may comprise more than one processor. For example, computing device 10 may comprise one or more central processing units (CPUs) 21, each of which itself has multiple processors or multiple processing cores, each capable of independently or semi-independently processing programming instructions. Further, computing device 10 may comprise one or more specialized processors such as a graphics processing unit (GPU) 22 configured to accelerate processing of computer graphics and images via a large array of specialized processing cores arranged in parallel.

System memory 30 is processor-accessible data storage in the form of volatile and/or nonvolatile memory. System memory 30 may be either or both of two types: non-volatile memory and volatile memory. Non-volatile memory 30a is not erased when power to the memory is removed, and includes memory types such as read only memory (ROM), electronically-erasable programmable memory (EEPROM), and rewritable solid-state memory (commonly known as “flash memory”). Non-volatile memory 30a is typically used for long-term storage of a basic input/output system (BIOS) 31, containing the basic instructions, typically loaded during computer startup, for transfer of information between components within computing device, or a unified extensible firmware interface (UEFI), which is a modern replacement for BIOS that supports larger hard drives, faster boot times, more security features, and provides native support for graphics and mouse cursors. Non-volatile memory 30a may also be used to store firmware comprising a complete operating system 35 and applications 36 for operating computer-controlled devices. The firmware approach is often used for purpose-specific computer-controlled devices such as appliances and Internet-of-Things (IoT) devices where processing power and data storage space is limited. Volatile memory 30b is erased when power to the memory is removed and is typically used for short-term storage of data for processing. Volatile memory 30b includes memory types such as random-access memory (RAM), and is normally the primary operating memory into which the operating system 35, applications 36, program subsystems 37, and application data 38 are loaded for execution by processors 20. Volatile memory 30b is generally faster than non-volatile memory 30a due to its electrical characteristics and is directly accessible to processors 20 for processing of instructions and data storage and retrieval. Volatile memory 30b may comprise one or more smaller cache memories which operate at a higher clock speed and are typically placed on the same IC as the processors to improve performance.

Interfaces 40 may include, but are not limited to, storage media interfaces 41, network interfaces 42, display interfaces 43, and input/output interfaces 44. Storage media interface 41 provides the necessary hardware interface for loading data from non-volatile data storage devices 50 into system memory 30 and storage data from system memory 30 to non-volatile data storage device 50. Network interface 42 provides the necessary hardware interface for computing device 10 to communicate with remote computing devices 80 and cloud-based services 90 via one or more external communication devices 70. Display interface 43 allows for connection of displays 61, monitors, touchscreens, and other visual input/output devices. Display interface 43 may include a graphics card for processing graphics-intensive calculations and for handling demanding display requirements. Typically, a graphics card includes a graphics processing unit (GPU) and video RAM (VRAM) to accelerate display of graphics. One or more input/output (I/O) interfaces 44 provide the necessary support for communications between computing device 10 and any external peripherals and accessories 60. For wireless communications, the necessary radio-frequency hardware and firmware may be connected to I/O interface 44 or may be integrated into I/O interface 44.

Non-volatile data storage devices 50 are typically used for long-term storage of data. Data on non-volatile data storage devices 50 is not erased when power to the non-volatile data storage devices 50 is removed. Non-volatile data storage devices 50 may be implemented using any technology for non-volatile storage of content including, but not limited to, CD-ROM drives, digital versatile discs (DVD), or other optical disc storage; magnetic cassettes, magnetic tape, magnetic disc storage, or other magnetic storage devices; solid state memory technologies such as EEPROM or flash memory; or other memory technology or any other medium which can be used to store data without requiring power to retain the data after it is written. Non-volatile data storage devices 50 may be non-removable from computing device 10 as in the case of internal hard drives, removable from computing device 10 as in the case of external USB hard drives, or a combination thereof, but computing device will typically comprise one or more internal, non-removable hard drives using either magnetic disc or solid-state memory technology. Non-volatile data storage devices 50 may store any type of data including, but not limited to, an operating system 51 for providing low-level and mid-level functionality of computing device 10, applications 52 for providing high-level functionality of computing device 10, program subsystems 53 such as containerized programs or applications, or other modular content or modular programming, application data 54, and databases 55 such as relational databases, non-relational databases, object oriented databases, BOSQL databases, and graph databases.

Applications (also known as computer software or software applications) are sets of programming instructions designed to perform specific tasks or provide specific functionality on a computer or other computing devices. Applications are typically written in high-level programming languages such as C++, Java, and Python, which are then either interpreted at runtime or compiled into low-level, binary, processor-executable instructions operable on processors 20. Applications may be containerized so that they can be run on any computer hardware running any known operating system. Containerization of computer software is a method of packaging and deploying applications along with their operating system dependencies into self-contained, isolated units known as containers. Containers provide a lightweight and consistent runtime environment that allows applications to run reliably across different computing environments, such as development, testing, and production systems.

The memories and non-volatile data storage devices described herein do not include communication media. Communication media are means of transmission of information such as modulated electromagnetic waves or modulated data signals configured to transmit, not store, information. By way of example, and not limitation, communication media includes wired communications such as sound signals transmitted to a speaker via a speaker wire, and wireless communications such as acoustic waves, radio frequency (RF) transmissions, infrared emissions, and other wireless media.

External communication devices 70 are devices that facilitate communications between computing device and either remote computing devices 80, or cloud-based services 90, or both. External communication devices 70 include, but are not limited to, data modems 71 which facilitate data transmission between computing device and the Internet 75 via a common carrier such as a telephone company or internet service provider (ISP), routers 72 which facilitate data transmission between computing device and other devices, and switches 73 which provide direct data communications between devices on a network. Here, modem 71 is shown connecting computing device 10 to both remote computing devices 80 and cloud-based services 90 via the Internet 75. While modem 71, router 72, and switch 73 are shown here as being connected to network interface 42, many different network configurations using external communication devices 70 are possible. Using external communication devices 70, networks may be configured as local area networks (LANs) for a single location, building, or campus, wide area networks (WANs) comprising data networks that extend over a larger geographical area, and virtual private networks (VPNs) which can be of any size but connect computers via encrypted communications over public networks such as the Internet 75. As just one exemplary network configuration, network interface 42 may be connected to switch 73 which is connected to router 72 which is connected to modem 71 which provides access for computing device 10 to the Internet 75. Further, any combination of wired 77 or wireless 76 communications between and among computing device 10, external communication devices 70, remote computing devices 80, and cloud-based services 90 may be used. Remote computing devices 80, for example, may communicate with computing device through a variety of communication channels 74 such as through switch 73 via a wired 77 connection, through router 72 via a wireless connection 76, or through modem 71 via the Internet 75. Furthermore, while not shown here, other hardware that is specifically designed for servers may be employed. For example, secure socket layer (SSL) acceleration cards can be used to offload SSL encryption computations, and transmission control protocol/internet protocol (TCP/IP) offload hardware and/or packet classifiers on network interfaces 42 may be installed and used at server devices.

In a networked environment, certain components of computing device 10 may be fully or partially implemented on remote computing devices 80 or cloud-based services 90. Data stored in non-volatile data storage device 50 may be received from, shared with, duplicated on, or offloaded to a non-volatile data storage device on one or more remote computing devices 80 or in a cloud computing service 92. Processing by processors 20 may be received from, shared with, duplicated on, or offloaded to processors of one or more remote computing devices 80 or in a distributed computing service 93. By way of example, data may reside on a cloud computing service 92, but may be usable or otherwise accessible for use by computing device 10. Also, certain processing subtasks may be sent to a microservice 91 for processing with the result being transmitted to computing device 10 for incorporation into a larger processing task. Also, while components and processes of the exemplary computing environment are illustrated herein as discrete units (e.g., OS 51 being stored on non-volatile data storage device 51 and loaded into system memory 35 for use) such processes and components may reside or be processed at various times in different components of computing device 10, remote computing devices 80, and/or cloud-based services 90.

In an implementation, the disclosed systems and methods may utilize, at least in part, containerization techniques to execute one or more processes and/or steps disclosed herein. Containerization is a lightweight and efficient virtualization technique that allows you to package and run applications and their dependencies in isolated environments called containers. One of the most popular containerization platforms is Docker, which is widely used in software development and deployment. Containerization, particularly with open-source technologies like Docker and container orchestration systems like Kubernetes, is a common approach for deploying and managing applications. Containers are created from images, which are lightweight, standalone, and executable packages that include application code, libraries, dependencies, and runtime. Images are often built from a Dockerfile or similar, which contains instructions for assembling the image. Dockerfiles are configuration files that specify how to build a Docker image. Systems like Kubernetes also support containers or CRI-O. They include commands for installing dependencies, copying files, setting environment variables, and defining runtime configurations. Docker images are stored in repositories, which can be public or private. Docker Hub is an exemplary public registry, and organizations often set up private registries for security and version control using tools such as Hub, JFrog Artifactory and Bintray, Github Packages or Container registries. Containers can communicate with each other and the external world through networking. Docker provides a bridge network by default, but can be used with custom networks. Containers within the same network can communicate using container names or IP addresses.

Remote computing devices 80 are any computing devices not part of computing device 10. Remote computing devices 80 include, but are not limited to, personal computers, server computers, thin clients, thick clients, personal digital assistants (PDAs), mobile telephones, watches, tablet computers, laptop computers, multiprocessor systems, microprocessor based systems, set-top boxes, programmable consumer electronics, video game machines, game consoles, portable or handheld gaming units, network terminals, desktop personal computers (PCs), minicomputers, main frame computers, network nodes, virtual reality or augmented reality devices and wearables, and distributed or multi-processing computing environments. While remote computing devices 80 are shown for clarity as being separate from cloud-based services 90, cloud-based services 90 are implemented on collections of networked remote computing devices 80.

Cloud-based services 90 are Internet-accessible services implemented on collections of networked remote computing devices 80. Cloud-based services are typically accessed via application programming interfaces (APIs) which are software interfaces which provide access to computing services within the cloud-based service via API calls, which are pre-defined protocols for requesting a computing service and receiving the results of that computing service. While cloud-based services may comprise any type of computer processing or storage, three common categories of cloud-based services 90 are microservices 91, cloud computing services 92, and distributed computing services 93.

Microservices 91 are collections of small, loosely coupled, and independently deployable computing services. Each microservice represents a specific computing functionality and runs as a separate process or container. Microservices promote the decomposition of complex applications into smaller, manageable services that can be developed, deployed, and scaled independently. These services communicate with each other through well-defined application programming interfaces (APIs), typically using lightweight protocols like HTTP, gRPC, or message queues such as Kafka. Microservices 91 can be combined to perform more complex processing tasks.

Cloud computing services 92 are delivery of computing resources and services over the Internet 75 from a remote location. Cloud computing services 92 provide additional computer hardware and storage on as-needed or subscription basis. Cloud computing services 92 can provide large amounts of scalable data storage, access to sophisticated software and powerful server-based processing, or entire computing infrastructures and platforms. For example, cloud computing services can provide virtualized computing resources such as virtual machines, storage, and networks, platforms for developing, running, and managing applications without the complexity of infrastructure management, and complete software applications over the Internet on a subscription basis.

Distributed computing services 93 provide large-scale processing using multiple interconnected computers or nodes to solve computational problems or perform tasks collectively. In distributed computing, the processing and storage capabilities of multiple machines are leveraged to work together as a unified system. Distributed computing services are designed to address problems that cannot be efficiently solved by a single computer or that require large-scale computational power. These services enable parallel processing, fault tolerance, and scalability by distributing tasks across multiple nodes.

Although described above as a physical device, computing device 10 can be a virtual computing device, in which case the functionality of the physical components herein described, such as processors 20, system memory 30, network interfaces 40, and other like components can be provided by computer-executable instructions. Such computer-executable instructions can execute on a single physical computing device, or can be distributed across multiple physical computing devices, including being distributed across multiple physical computing devices in a dynamic manner such that the specific, physical computing devices hosting such computer-executable instructions can dynamically change over time depending upon need and availability. In the situation where computing device 10 is a virtualized device, the underlying physical computing devices hosting such a virtualized computing device can, themselves, comprise physical components analogous to those described above, and operating in a like manner. Furthermore, virtual computing devices can be utilized in multiple layers with one virtual computing device executing within the construct of another virtual computing device. Thus, computing device 10 may be either a physical computing device or a virtualized computing device within which computer-executable instructions can be executed in a manner consistent with their execution by a physical computing device. Similarly, terms referring to physical components of the computing device, as utilized herein, mean either those physical components or virtualizations thereof performing the same or equivalent functions.

As can now be appreciated, disclosed embodiments provide improvements in data compression for SAR images. Disclosed embodiments provide a subband learning-based compression solution for SAR image compression, which has a divide-and-conquer strategy in dealing with redundancy in images by having a neural network encoder of latent representation, followed by a multi-stage context model that drives an arithmetic coding engine. This enables compressing of SAR images to reduce their file size, allowing for more efficient use of storage resources. Disclosed embodiments utilize a multiple pass amplitude compression scheme, which when combined with InSAR phase input, provides information for deriving unwrapped phase. Thus, disclosed embodiments provide improvements in InSAR phase recovery. Furthermore, the compressed SAR images require less bandwidth for transmission, making it faster to send and receive data over networks, including satellite links and the internet. Thus, disclosed embodiments enable SAR images to be transmitted more efficiently, promoting important applications such as environmental monitoring, reconnaissance, surveillance, meteorology, and others.

The skilled person will be aware of a range of possible modifications of the various aspects described above. Accordingly, the present invention is defined by the claims and their equivalents.

What is claimed is:

1. A system for processing Synthetic Aperture Radar (SAR) data using cross polarization prediction, comprising:
a computing device comprising at least a memory and a processor;
a plurality of programming instructions stored in the memory and operable on the processor, wherein the plurality of programming instructions, when operating on the processor, cause the computing device to:
process complex SAR data gathered using a first polarization;
process complex SAR data gathered using a second polarization;
store representations of both first and second polarization data;
reconstruct the processed first polarization data using a reconstruction component;
utilize the processed second polarization data as auxiliary information in the reconstruction component to influence the reconstruction of first polarization data; and
generate modified or enhanced SAR data based on the processed representations of the first and second polarization data.

2. The system of claim 1, wherein processing the complex SAR data comprises compressing the data using a compression algorithm.

3. The system of claim 2, wherein the compression algorithm is a neural network-based compression algorithm trained to efficiently compress both first and second polarization SAR data.

4. The system of claim 1, wherein the reconstruction component is a neural network trained to leverage correlations between the first and second polarizations for improved reconstruction accuracy.

5. The system of claim 1, wherein the computing device is further caused to:
analyze the processed representations to extract features that are common or distinct between the first and second polarizations; and
use the extracted features to enhance the reconstruction process or to derive additional information about the imaged scene.

6. The system of claim 1, wherein the computing device is further caused to:
adapt the processing and reconstruction based on specific characteristics of the SAR data, including factors such as terrain type, incidence angle, and radar frequency.

7. The system of claim 1, wherein the first polarization is HH polarization and the second polarization is VV polarization.

8. The system of claim 1, wherein generating modified or enhanced SAR data comprises at least one of:
interpolation between the first and second polarizations;
extrapolation of polarization effects; and
arithmetic operations on the processed representations.

9. A method for processing Synthetic Aperture Radar (SAR) data using cross polarization prediction, comprising the steps of:
acquiring complex SAR data using both a first polarization process and a second polarization process;
processing both first and second polarization data;
storing representations of both first and second polarization data;
reconstructing the processed first polarization data using a reconstruction component that utilizes the processed second polarization data as auxiliary information; and
generating modified or enhanced SAR data based on the processed representations of the first and second polarization data.

10. The method of claim 9, further comprising the step of analyzing the processed representations to derive additional information about the imaged scene based on the relationships between first and second polarization data.

11. The method of claim 9, wherein the step of generating modified or enhanced SAR data includes at least one of:
performing interpolation between first and second polarization data to simulate intermediate polarization states;
extrapolating polarization effects to predict SAR data for novel viewing geometries or radar configurations; and
applying arithmetic operations to the processed representations to enhance specific features or characteristics of the SAR data.

12. The method of claim 9, wherein processing both first and second polarization data comprises compressing the data using an identical compression algorithm.
